(19) United States
(12) Patent Application Publication
(10) Pub. No.: US 2016/0029667 A1
(43) Pub. Date: Feb. 4, 2016

(54) IMPROVED MEAT SLURRY METHODS OF PRODUCTION AND COMPOSITIONS

(71) Applicant: MICRO-NATURE LLC, San Francisco, CA (US)

(72) Inventors: Richard Baird SMITTLE, Morgantown, WV (US); John Boyd PHELPS,, Andover, NJ (US); Gregory Dean SUNVOLD, Lewisburg, OH (US)

(21) Appl. No.: 14/777,394

(22) PCT Filed: Mar. 17, 2014
(86) PCT No.: PCT/US2014/030118

§ 371 Date: Sep. 15, 2015

Related U.S. Application Data
(63) Continuation-in-part of application No. 13/838,314, filed on Mar. 15, 2013, now abandoned.

(51) Int. Cl. A23K 1/10; A23B 4/22; A23K 1/00

(52) U.S. Cl. CPC A23K 1/10; A23K 1/009; A23B 4/22; A23V 2002/00

(57) ABSTRACT

A process for producing a meat slurry is described. The process includes: (i) obtaining an animal source of protein; (ii) reducing piece size of the animal source of protein to produce a smaller-piece-sized animal source of protein; (iii) introducing one or more types of lactic acid producing bacteria and at least one carbohydrate energy source to the smaller-piece-sized animal source of protein to produce a meat mixture; (iv) adding water to the meat mixture to produce an activated meat mixture; (v) incubating the activated meat mixture to produce a meat slurry; and wherein the activated meat mixture has a pH value that is greater than about 5.0, and wherein prior to incubating, the lactic acid producing bacteria is present on the meat mixture in an amount that is at least about 1×107 colony forming units (“CFU”) of lactic acid producing bacteria per gram of said meat mixture, and wherein after incubating, the lactic acid producing bacteria produces lactic acid in an amount that is sufficient to maintain a pH of the meat slurry at a value that is no greater than about 4.7.

### RELATED CASE

This application claims priority to a U.S. patent application Ser. No. 13/838,314, filed on Mar. 15, 2013, and is incorporated by reference for all purposes.

### FIELD

The present teachings relate generally to improved meat slurry methods of production and compositions. More specifically, the present teachings relate to meat-based ingredients that have a relatively longer shelf-life and that may be included in a food product intended for human or animal use.

### BACKGROUND

Food products, and in particular, pet food products, are typically made up of several different ingredients, including meat. In certain food products, it is most economical to use meat scraps that would otherwise be considered waste. Within the pet food industry, the current practice in handling meat scraps entails collecting meat scraps from a slaughtering and then freezing these meat scraps. Due to concerns with product spoilage, however, the meat scraps must be used within five days of animal slaughter. While this practice may be made feasible by using refrigeration transport trucks and refrigeration supply chain, this is a costly and inefficient solution and places significant pressure on manufacturers to use all frozen meats within such a short period of time. In addition, current guidance by the FDA advises frozen transport of meats used in pet foods. As such, persons working in the meat ingredient supply industry have become accustomed to a long-standing practice of freezing meat during transport to pet food manufacturing plants.

Manufacturing a complete pet food is currently accomplished in a number of ways. The most common commercial manufacturing technique involves extruding the meal into a complete formed kibble. Kibbles provide certain advantages, including being a relatively shelf-stable product that does not require transport of significant amounts of water, as it is typically a dry food (i.e., less than 10% moisture content). Another common commercial manufacturing technique involves retorting the food into a small (e.g., single-serve) package. Retorted pet food is regarded as one of the most palatable pet food product forms. Further, as certain pets (such as cats) are susceptible to the formation of kidney/urinary stones, retorted pet food provides the advantage of a relatively larger amount of water, which helps reduce the likelihood of stone formation. While other product formats exist that could provide a complete pet food, e.g., such as baked biscuits, semi moist (20% to 40% moisture) and chubb formats (40% moisture), these formats are typically regarded by consumers as “supplemental” formats and are not intended to replace the required nutrition for one's pet.

Regardless of the form of pet food manufactured, all product formats typically require a heating step to deactivate pathogenic and/or spoilage microorganisms typically associated with meats. Some examples of pathogenic microorganisms include Salmonella, pathogenic E. coli, and Clostridia.

One example of making such a pet food product is contained within U.S. Pat. No. 4,041,181. This disclosure is herein incorporated by reference. This patent describes the making of a pet food product that contains fermented and autolyzed proteinaceous material, usually some form of animal tissue, that is bound by a gelled binder and stabilized against microbiological activity by an acid pH. The product has an antimycotic added to it and the product is then shaped by extrusion and cooked.

While U.S. Pat. No. 4,041,181 involves the addition of microbes to meat, it is a finished pet food product and requires that the product be shaped and heated (cooked within an extruder). It further indicates that a binder be added to create a texture that is chewy in nature and a humectant to control water activity of the product. The problem with this approach is that the meat is cooked with an extruder and other additives such as the binder and humectant transform the meat into a finished product. This requires much energy expenditure and does not solve the question of how to extend the shelf-life of the meat slurry ingredient before it is used in a pet food finished product.

Accordingly, there is a continuing unmet need to extend the shelf-life of meat slurry ingredients used in the production of finished pet food products.

What is therefore needed are methods, and compositions that can be used to treat the surface of food products, to reduce pathogen activity on those food products, in a safe and effective manner.

### SUMMARY OF THE INVENTION

In one aspect, the present teachings disclose a meat slurry composition. The meat slurry composition includes (i) an animal source of protein; (ii) one or more types of lactic acid producing bacteria; (iii) lactic acid; and (iv) water; and wherein the meat slurry composition is in a liquefied or a semi-liquefied state, and lactic acid is produced by one or more types of lactic acid producing bacteria in an amount that is sufficient to maintain a pH value of the meat slurry composition at less than about 4.7.

In another aspect, the present teachings disclose an activated meat mixture composition. The activated meat mixture composition includes: (i) an animal source of protein; (ii) one or more types of lactic acid producing bacteria; (iii) at least one carbohydrate energy source; and (iv) water; and wherein the animal source of protein is in a substantially piece-size-reduced state, the composition has a pH value that is greater than about 5.0, and one or more types of lactic acid producing bacteria are present on the activated meat mixture in an amount that is at least about 1×10⁷ colony forming units (“CFU”) of bacteria per gram of the activated meat mixture composition.

In yet another aspect, the present teachings disclose a process for producing a meat slurry. The process includes: (i) obtaining an animal source of protein; (ii) reducing piece size of the animal source of protein to produce a smaller-piece-sized animal source of protein; (iii) introducing one or more types of lactic acid producing bacteria and at least one carbohydrate energy source to the smaller-piece-sized animal source of protein to produce a meat mixture; (iv) adding water to the meat mixture to produce an activated meat mixture; and (v) incubating the activated meat mixture to produce a meat slurry; and wherein the activated meat mixture has a pH value that is greater than about 5.0, and wherein prior to incubating, one or more types of lactic acid producing bacteria are present on the meat mixture in an amount that is at least about 1×10⁷ colony forming units (“CFU”) of one or more types of lactic acid producing bacteria per gram of the meat mixture; and after incubating, one or more types of lactic acid producing bacteria produces lactic acid in an amount that is sufficient to maintain a pH of the meat slurry at a value that is no greater than about 4.7.

According to one preferred embodiment of the present teachings, a process for producing a meat slurry further includes: (i) retaining a portion of the meat slurry; (ii) adding, to the portion of the meat slurry, the same or another of the smaller-piece-sized animal source of protein, to produce a smaller piece-sized animal source of protein/meat slurry combination; (iii) mixing the smaller-piece-sized animal source of protein/meat slurry combination to produce a smaller-piece-sized animal source of protein/meat slurry mixture; (iv) introducing, to the smaller-piece-sized animal source of protein/meat slurry mixture, the same or another of the carbohydrate energy source and water to produce an activated, smaller-piece-sized animal source of protein/meat slurry mixture; and (v) incubating the activated, smaller-piece-sized animal source of protein/meat slurry mixture to produce another meat slurry that is enriched with sufficient lactic acid, produced by one or more types of lactic acid producing bacteria, such that a pH value of another meat slurry is less than about 4.7.

In yet another aspect, the present teachings disclose another process for producing a meat slurry. The process includes: (i) obtaining an animal source of protein; (ii) reducing piece size of the animal source of protein to produce a smaller-piece-sized, animal source of protein; (iii) adding at least one proteolytic enzyme to the smaller-piece-sized animal source of protein to produce a pre-digested, smaller-piece-sized animal source of protein; (iv) digesting the pre-digested smaller-piece-sized animal source of protein to produce a digested smaller-piece-sized animal source of protein; (v) introducing one or more types of lactic acid producing bacteria and at least one carbohydrate energy source to the digested animal source of protein to produce a digested meat mixture; and (vi) incubating the digested meat mixture to produce a digested meat slurry; and wherein the digested meat mixture has a pH value that is greater than about 5.0, and after introducing one or more types of lactic acid producing bacteria and at least one carbohydrate energy source, the lactic acid producing bacteria is present on the digested meat mixture in an amount that is at least about 1×10⁷ CFU of bacteria per gram of digested meat mixture, and the digested meat slurry has a pH value that is maintained at a level that is less than about 4.7.

### BRIEF DESCRIPTION OF THE DRAWINGS

FIG. 1 is a flowchart of a process 100, according to one preferred embodiment of the present teachings, showing certain salient steps for producing a meat slurry.

FIG. 2 is a flowchart of a process 200, according to another preferred embodiment of the present teachings, showing certain salient steps for producing an enzymatically digested meat slurry.

FIG. 3 is a flowchart of a process 300, according to another preferred embodiment of the present teachings, showing certain salient steps for producing a meat slurry using another meat slurry as an inoculant source.

FIG. 4 is a line graph, according to one preferred embodiment of the present teachings, showing changes in survival of Salmonella surrogates and pH values, over time, during incubation of a meat slurry.

FIG. 5 is a line graph, according to another preferred embodiment of the present teachings, showing changes in survival of Salmonella surrogates and pH values, over time, during incubation of a meat slurry.

### DETAILED DESCRIPTION OF THE PREFERRED EMBODIMENTS

In the following description numerous specific details are set forth in order to provide a thorough understanding of the present teachings. It will be apparent, however, to one skilled in the art that the present teachings may be practiced without limitation to some or all of these specific details. In other instances, well known process steps have not been described in detail in order to not unnecessarily obscure the present teachings.

As used herein, the articles including “the”, “a” and “an” when used in a claim or in the specification, are understood to mean one or more of what is claimed or described.

As used herein, the terms “include”, “includes” and “including” are meant to be non-limiting.

As used herein, the term “animal” and “pet” means a domestic animal including, but not limited to, domestic dogs, cats, horses, cows, ferrets, rabbits, pigs and the like. Domestic dogs and cats are particular examples of pets.

As used herein, the terms “pet food” means a composition intended for ingestion by a pet. Pet foods may include, without limitation, nutritionally balanced compositions suitable for daily feed, as well as supplements (e.g., treats) may or may not be nutritionally balanced.

All percentages and ratios are calculated and provided by weight unless otherwise indicated. All percentages and ratios are calculated and provided based on the total composition unless otherwise indicated.

Referenced herein may be trade names for components including various ingredients utilized in the present disclosure. The inventors herein do not intend to be limited by materials under any particular trade name. Equivalent materials (e.g., those obtained from a different source under a different name or reference number) to those referenced by trade name may be substituted and utilized in the descriptions herein.

In the description of the various embodiments of the present disclosure, various embodiments or individual features are disclosed. As will be apparent to the ordinarily skilled practitioner, all combinations of such embodiments and features are possible and can result in preferred executions of the present disclosure. While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

As disclosed in further detail herein, the present teachings recognize that incubating a meat product with a lactic acid producing bacteria is juxtaposed to current industry practice, which avoids bacterial growth (in particular, growth of food-borne pathogens such as Salmonella and certain strains of E. coli), by cooling, during preparation, meat products that are used in finished pet and human food products. This is intended to limit spoilage bacterial growth and to limit certain yeast and certain mold growth, thus limiting food degradation. It is surprising, then, that, as explained below, the present teachings require growth of certain bacteria to create conditions that inhibit the growth or survival of certain bacterial food-borne pathogens (e.g., Salmonella and certain strains of E. coli). Further, it is noteworthy that using bacteria to control bacterial growth in a meat slurry produced according to the present teachings is possible at a range of storage conditions, including relatively higher temperatures, under which growth of food-borne pathogens is typically accelerated, as well as relatively longer time periods.

In one aspect, the present teachings disclose a meat slurry composition. As used herein, a meat slurry composition may be thought of as a liquefied or semi-liquefied meat product that uses fermentation byproducts to facilitate inhibition of pathogen growth and/or survival therein. In certain embodiments of the present teachings, a meat slurry composition may be in a state that is at least one member selected from a group comprising homogenous, liquefied, emulsified, and pumpable. In certain other embodiments of the present teachings, the meat slurry composition is flowable, which means that the meat slurry is capable of flowing from one location to another. According to the present teachings, a meat slurry composition is used as or in an animal or a human food products and provides an extended shelf-life to those food products.

According to one embodiment of the present teachings, a meat slurry composition comprises an animal source of protein, one or more types of lactic acid producing bacteria, lactic acid, and water. Lactic acid is present in a meat slurry composition in an amount that is sufficient to maintain a pH value of a meat slurry composition at a level that is less than about 4.7. According to the present teachings, this pH value is sufficient to facilitate inhibition of growth and/or survival of pathogens, including Salmonella, and certain strains of mold and/or yeast, in a meat slurry composition. In certain embodiments of the present teachings, a meat slurry composition further comprises one or more bacterial metabolites and/or fermentation byproducts that further facilitate inhibition of growth and/or survival of pathogens, including pathogenic bacteria, yeast, and mold.

An animal source of protein includes at least one member selected from a group comprising chicken, turkey, poultry, beef, pork, lamb, goat, buffalo, kangaroo, rabbit, and venison. In certain embodiments of the present teachings, a meat slurry composition includes more than one animal source of protein. While the main parts of an animal used in a meat slurry composition for human consumption may often include skeletal muscle, in preferred embodiments of the present teachings, an animal source of protein includes components that are thought to be less desirable (and which are often used as components of food for animal consumption), including at least one member selected from a group comprising a gullet, a trachea, a liver, a heart, a kidney, an intestine, a stomach, cartilage, and meat trimmings from residual skeletal muscle. The present teachings contemplate an animal source of protein in a meat slurry composition that is at least one member selected from a group comprising raw, pasteurized, seared, poached, blanched, braised, cooked, and uncooked.

An animal source of protein in a meat slurry composition is in a substantially reduced state. According to preferred embodiments of the present teachings, a piece-size of a substantial amount of an animal source of protein in a meat slurry composition has a largest dimension that does not exceed about 20 mm, and more preferably, does not exceed about 10 mm

According to preferred embodiments of the present teachings, a meat slurry composition includes at least one lactic acid producing bacteria selected from a group comprising Pediococcus acidilactici, Pediococcus pentosaceus, Lactococcus lactis, Lactococcus cremoris, Lactobacillus delbruckii var bulgaricus, Lactobacillus plantarum, Lactobacillus pentosum, Streptococcus thermophilus, Lactobacillus sakei, and Lactobacillus curvatus. In one preferred embodiment of the present teachings, a meat slurry composition includes Pediococcus acidilactici and Pediococcus pentosaceus.

Lactic acid producing bacteria in a meat slurry composition may be in a state that is at least one member selected from a group comprising dormant, lag, living, logarithmic growth, stationary, and dead. Because a meat slurry composition has a pH value of less than about 4.7, bacteria in a meat slurry composition are typically not growing. In certain embodiments of the present teachings, a meat slurry composition includes bacteria in an amount that is at least about 1×10⁹ colony forming units (“CFU”) per gram of meat slurry composition (expressed in units of “CFU/g”). In other embodiments of the present teachings, a meat slurry composition includes bacteria in an amount that is at least about 1×10⁷ CFU/g of meat slurry composition.

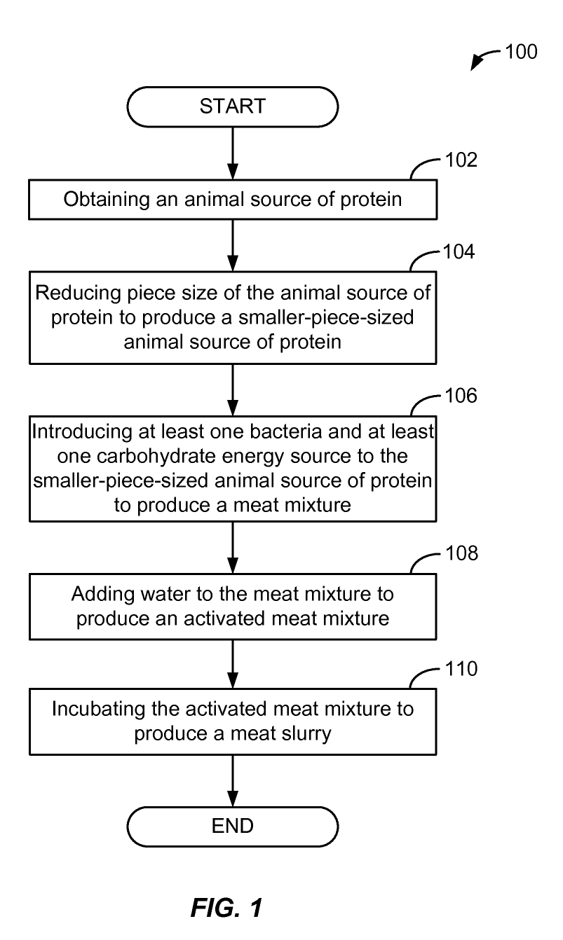

According to preferred embodiments of the present teaching, a meat slurry composition has a moisture content that is at least about 65%, or more preferably, at least about 74%, by weight. In certain embodiments of the present teachings, such as when a meat mixture composition uses a seafood animal source of protein, a meat slurry composition may have a moisture content that is at least about 80%, by weight, may be used. Water in a meat slurry composition primarily includes water that is present due to a meat slurry production step that reduces a piece size of an animal source of protein (described below with reference to step 104 of FIG. 1). In other words, an animal source of protein provides a source of water that is included in a meat slurry composition. In certain embodiments of the present teachings, water is also added prior to an incubation step that is used to produce a meat slurry composition (described below with reference to step 108 of FIG. 1). In other embodiments of the present teachings, water is added at any time during the production of a meat slurry composition.

In certain embodiments of the present teachings, a meat slurry composition further includes, along with lactic acid, at least one other bacterial metabolite and/or fermentation byproduct selected from a group comprising phenyllactic acid, 3-hydroxyphenyllactic acid, 4-hydroxyphenylactic acid, 3-hydroxy propanaldehyde, 1,2 propandiol, 1,3 propandiol, hydrogen peroxide, ethanol, acetic acid, carbon dioxide, carbonic acid, propanoic acid, butyric acid, cyclic dipeptides, cyclo(L-Phe-L-Pro), cyclo(L P-Traps-4-OH-L-Pro), 3-(R)-hydroxydecanoic acid, 3-hydroxy-5-cic dodecanoic acid, 3-(R)-hydroxy dodecanoic acid, and 3-(R)-hyroxytetradecanoic acid. In other embodiments of the present teachings, a meat slurry composition includes a bacteriocin that is a lantibiotic (Class II) or a non-lantibiotic (Class II). In other embodiments of the present teachings, a meat slurry composition includes a bacteriocin that includes at least one member selected from a group comprising nisin A, nisin Z, nisin Q, nisin F, nisin U, nisin U2, salivarcin X, lacticin J46, lacticin 481, lacticin 3147, salivarcin A, salivarcin A2, salivarcin A3, salivarcin A4, salivarcin A5, salivarcin B, streptin, salivaricin A1, streptin, streptococcin A-FF22, BHT-Aa, BHT Ab, mutacin BNY266, mutacin 1140, mutacin K8, mutacin II, smbAB, bovicin HJ50, bovicin HC5, macedocin, plantaricin W, lactocin 5, cyctolysin, enterocin A, divercin V41, divercin M35, bavaricin, coagulin, pediocin PA-1, mundticin, piscicocin CS526, piscicocin 126/V1a, sakacin P, leucocin C, sakacin 5X, enterocin CRL35/mundticin, avicin A, mundticin I, enterocin HF, bavaricin A, ubericin A, leucocin A, mesentericin Y105, sakacin G, plantaricin 423, plantaricin C19, curvacin A/Sakacin A, carnobacteriocin BM1, enterocin P, piscicoin VIb, penocin A, bacteriocin 31, bacteriocin RC714, hiracin JM79, Bacteriocin T8, enterocin SE-K4, carnobacteriocin B2, SRCAM 1580, and CONCENSUS.

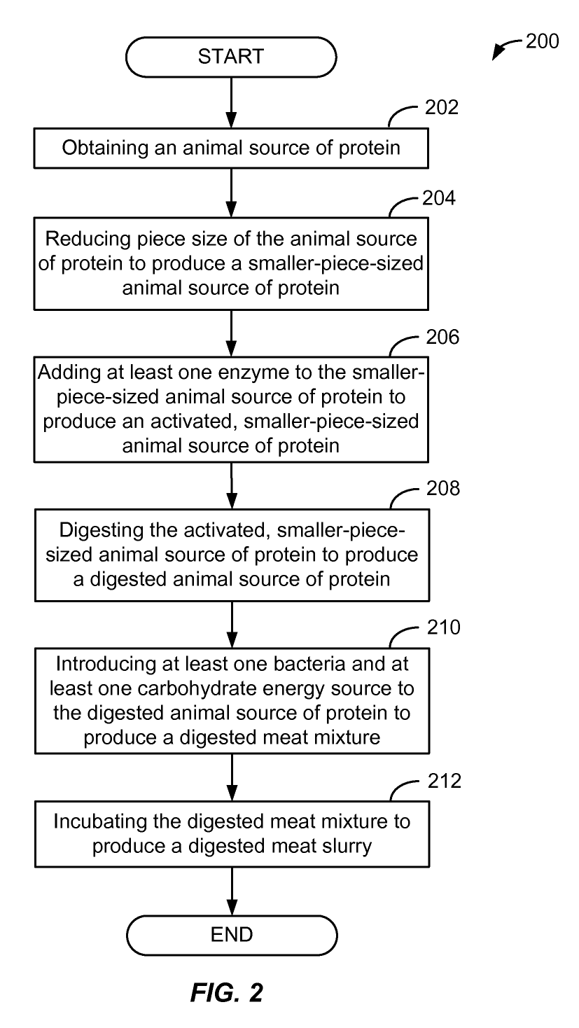

According to certain embodiments of the present teachings, a meat slurry composition further comprises one or more proteolytic enzymes selected from a group comprising a protease, a peptidase, an exo-peptidase, and an endo-peptidase. In other embodiments of the present teachings, one or more proteolytic enzymes may be at least one member selected from a group comprising sulfhydryl protease, serine protease, alcalase, flavourzyme, protamex, liquipanol, papain, bromelain, ficin, an enzyme from Aspergillus oryzae, an enzyme from Bacillus subtilis var amyloliquifacians, a protease from Bacillus licheniformis, and pepsin from porcine and chicken stomachs. A proteolytic enzyme may be obtained in commercially available meat tenderizers, including those that serve as a source of bromelain (available from Parchem Fine & Specialty Chemicals located in New Rochelle, N.Y., from Nutriteck Bulk Products Division of Ultra Bio-Logics Inc. located in Rigaud, QC Canada, or from Lawry's Foods, LLC located in Sparks, Md., as found in as Adolph's® meat tenderizer), or those that serve as a source of papain (available Kroger® located in Cincinnati, Ohio as found in Kroger® Meat Tenderizer). In such embodiments, a proteolytic enzyme is used to digest an animal source of protein during production of a meat slurry composition (explained below with reference to step 208 of FIG. 2). In such manner, a meat slurry composition is referred to as a digested meat slurry composition. As a result of digestion facilitated by one or more proteolytic enzymes, a digested meat slurry composition may be relatively less viscous and more liquefied, emulsified, pumpable, and/or flowable than a meat slurry composition.

As explained further below, a meat slurry composition (including a digested meat slurry) may be prepared as or added to food for consumption by a human or animal. According to certain embodiments of the present teachings, a meat slurry is used to prepare at least one member chosen from a group comprising a liquid digest, a puree, a gravy, a paste, a loaf, a chub, a dough, and an emulsion.

In another aspect, the present teachings disclose an activated meat mixture composition. An activated meat mixture composition may be thought of as a precursor to a meat slurry composition, prior to an incubation step that produces a meat slurry (described below with reference to step 106 of FIG. 1). An activated meat mixture composition includes components sufficient to facilitate fermentation of lactic acid producing bacteria under appropriate treatment conditions (e.g., temperature and time), and in such manner, is thought to be “activated.”

An activated meat slurry composition comprises an animal source of protein, one or more types of lactic acid producing bacteria, at least one carbohydrate energy source, and water. Because lactic acid producing bacteria in an activated meat mixture composition have not undergone fermentation, lactic acid is not present to an appreciable degree. Accordingly, an activated meat mixture composition has a pH value that is greater than about 5.0, which is sufficient to promote bacterial and pathogen growth. In certain embodiments of the present teachings, an activated meat mixture composition has a pH value that is greater than about 5.5.

An animal source of protein in an activated meat mixture is substantially similar to an animal source of protein described above with reference to a meat slurry composition. Because an activated meat mixture composition has not undergone incubation in the presence of lactic acid and heat, however, an animal source of protein in an activated meat mixture composition may provide an activated meat mixture composition that is relatively more viscous, less liquefied, less emulsified, and/or less homogenous than a meat slurry composition.

Lactic acid producing bacteria in an activated meat mixture composition is substantially similar to lactic acid producing bacteria disclosed above with reference to a meat slurry composition. Unlike lactic acid producing bacteria in a meat slurry composition, however, lactic acid producing bacteria in an activated meat mixture composition has not undergone fermentation. Accordingly, in preferred embodiments of the present teachings, lactic acid producing bacteria in an activated meat mixture composition is in a substantially growing state. According to one embodiment of the present teachings, lactic acid producing bacteria in an activated meat mixture composition is present in an amount that is at least about 1×10⁴ CFU/g of activated meat mixture. In another embodiment of the present teachings, lactic acid producing bacteria in an activated meat mixture composition is present in an amount that is at least about 1×10⁵ CFU/g of activated meat mixture. In yet another embodiment of the present teachings, lactic acid bacteria in an activated meat mixture composition is present in an amount that is at least about 1×10⁹ CFU/g of meat mixture.

A carbohydrate energy source is a composition of fermentable carbohydrates in a liquid composition that serves a beneficial role of providing a fuel source to aid the fermentation of lactic acid producing bacteria used to produce a meat slurry composition, according to the present teachings. A carbohydrate energy source includes at least one member chosen from a group comprising apple juice, apple juice concentrate, dextrose, dextrose monohydrate, dextrose hydride, grape sugar, D-glucose, corn sugar, corn syrup solids, hydrolyzed corn syrup, levulose, glucose, fructose, galactose, xylose, ribose, mannose, sorbose, high fructose corn syrup, apple pulp, honey, sugar, maple syrup, pear juice, grape juice, orange juice, fruit juice, and lactose. An activated meat mixture includes between about 2.5 mg and about 50 mg of a carbohydrate energy source per gram of activated meat mixture, and preferably, between about 10 mg and about 20 mg of carbohydrate energy source per gram of activated meat mixture. In certain embodiments of the present teachings, an activated meat mixture includes between about 1% and about 2%, by weight, of a carbohydrate energy source.

According to preferred embodiments of the present teachings, an activated meat mixture composition has a moisture content that is at least about 65%, by weight, and more preferably, at least about 74%, by weight. In certain embodiments of the present teachings, seafood sources of protein may provide an activated meat mixture composition that has a moisture content that is at least about 80%, by weight. The sources of water in an activated meat mixture composition are substantially similar to those described above with reference to a meat slurry composition. Unlike water in a meat slurry composition, however, water in an activated meat mixture composition requires a water activity value that is sufficient to promote fermentation of lactic acid producing bacteria. Accordingly, in preferred embodiments of the present teachings, water in an activated meat slurry composition has a water activity value that is at least about 0.95.

In certain embodiments of the present teachings, an activated meat mixture composition comprises one or more proteolytic enzymes, which are substantially similar to their counterparts, described above with reference to a meat slurry composition. In certain embodiments of the present teachings, an activated meat slurry mixture has undergone digestion by one or more proteolytic enzymes, and as such, may be considered a digested, activated meat mixture composition. In alternate embodiments of the present teachings, however, a meat slurry composition that includes one or more proteolytic enzymes will undergo digestion at the same time as lactic acid fermentation that produces a meat slurry composition.

In another aspect, a process for producing a meat slurry is disclosed. To this end, FIG. 1 is a flowchart for a process 100, according to one preferred embodiment of the present teachings, showing certain salient steps for producing a meat slurry. Process 100 begins with a step 102, which includes obtaining an animal source of protein. An animal source of protein may be obtained from a slaughterhouse. According to one embodiment of the present teachings, an animal source of protein includes at least one member selected from a group comprising chicken, turkey, poultry, beef, pork, lamb, goat, buffalo, kangaroo, rabbit, and venison. In certain embodiments of the present teachings, more than one animal source of protein is obtained for use in subsequent steps. Any animal source of protein may be any part of an animal that is edible, including at least one a gullet, a trachea, a liver, a heart, a kidney, an intestine, a stomach, cartilage, and meat trimmings from residual skeletal muscle. The present teachings contemplate use of an animal source of protein this is in a state that is at least one member selected from a group comprising raw, pasteurized, seared, poached, blanched, braised, cooked, and uncooked.

Next, a step 104 includes reducing piece size of the animal source of protein to produce a smaller-piece-sized animal source of protein. An animal source of protein has a moisture content that is at least about 70% moisture, by weight (though in seafood sources of protein, this value may be at least about 80% moisture, by weight), thus reducing the piece size of the animal source of protein also provides water that is used as part of a meat slurry

Reducing a piece size of an animal source of protein may be carried out by at least one technique selected from a group comprising emulsifying, grinding, and deboning. In certain embodiments of the present teachings, reducing a piece size of an animal source of protein may be facilitated by use of a piece-sizing device or technique that is at least one member selected from a group comprising a chopper, a grinder, a cutter, a mechanical separator, a deboner, an emulsifier, a flaker, an extructor, a block breaker, a beehive, a pre-breaker, dicer, and deboning by hand. According to preferred embodiments of the present teachings, a substantial amount of a smaller-piece-sized animal source of protein produced by step 104 has a largest dimension that does not exceed about 20 mm, and more preferably, does not exceed about 10 mm

While FIG. 1 shows step 104 being carried out as a single step, in alternate embodiments of the present teachings, step 104 is carried out in multiple steps. By way of example, a two-step process involving coarse grinding followed by fine grinding may be used to produce an emulsified animal source of protein. Coarse grinding may be carried out using a continuous meat grinder (e.g., a commercially available unit manufactured by Weiler & Company or Wolfking & Company). Such coarse grinding is facilitated by using holeplate hole sizes that are between about 3 mm and about 10 mm, producing piece sizes of an animal source of protein that generally do not exceed that hole size. Next, fine grinding may be carried out by a standard meat slurry emulsification unit (e.g., a commercially available unit manufactured by Karl Schnell or Wolfking & Company). In such embodiments, holeplate hole sizes may be between about 1.7 mm and about 6.0 mm It is important to note that the output temperature from the fine-grinding step should not exceed a temperature value that is between about 77° F. to about 95° F., as such conditions may cook an animal source of protein and/or stimulate pathogen growth.

Step 104 may include other techniques that facilitate reducing a piece size of an animal source of protein. By way of example, a mechanical device may be used to separate meat trimmings from bone. As another example, an animal source of protein may be ground up and heated to separate protein from animal fat.

In one preferred embodiment of the present teachings, prior to reducing a piece size of an animal source of protein in step 104, an animal source of protein is maintained at a temperature value that is between about 32° and about 55° F. In another embodiment of the present teachings, prior to step 104, an animal source of protein is maintained at a temperature value that is less than or equal to about 32° F. (i.e., frozen). In yet another embodiment of the present teachings, prior to step 104, an animal source of protein is maintained, for at least 15 minutes, at a temperature value that is between about 55° F. and about 95° F.

Next, a step 106 includes introducing one or more types of lactic acid producing bacteria and at least one carbohydrate energy source to the smaller-piece-sized animal source of protein to produce a meat mixture. Bacteria used to inoculate a smaller-piece-sized animal source of protein preferably includes a lactic acid producing bacteria. According to preferred embodiments of the present teachings, a bacteria includes at least one member selected from a group comprising Pediococcus acidilactici, Pediococcus pentosaceus, Lactococcus lactis, Lactococcus cremoris, Lactobacillus delbruckii var bulgaricus, Lactobacillus plantarum, Lactobacillus pentosum, Streptococcus thermophilus, Lactobacillus sakei, and Lactobacillus curvatus. In one preferred embodiment of the present teachings, Pediococcus acidilactici and Pediococcus pentosaceus are both introduced to a smaller-piece-sized animal source of protein.

In step 106, a smaller-piece-sized animal source of protein (which includes water released from an animal source of protein during step 104) is inoculated with one or more types of lactic acid producing bacteria. In one preferred embodiment of the present teachings, a meat mixture produced in step 106 includes at least about 1×10⁷ CFU/g of meat mixture. In alternate embodiments of the present teachings, a meat mixture is inoculated with at least about 1×10⁴ CFU/g or at least about 1×10⁹ CFU/g.

According to preferred embodiments of the present teachings, a meat mixture produced by step 106 includes a carbohydrate energy source. A carbohydrate energy source may include at least one member selected from a group comprising apple juice, apple juice concentrate, dextrose, dextrose monohydrate, dextrose hydride, grape sugar, D-glucose, corn sugar, corn syrup solids, hydrolyzed corn syrup, levulose, glucose, fructose, galactose, xylose, ribose, mannose, sorbose, high fructose corn syrup, apple pulp, honey, sugar, maple syrup, pear juice, grape juice, orange juice, fruit juice, and lactose. Step 106 may include introducing between about 2.5 mg and about 50 mg of a carbohydrate energy source per gram of meat mixture, and more preferably, between about 10 mg and about 20 mg of carbohydrate energy source per gram of meat mixture. In certain embodiments of the present teachings, a meat mixture includes between about 1% and about 2%, by weight, of a carbohydrate energy source.

According to certain embodiments of the present teachings, step 106 includes introducing bacteria and a carbohydrate energy source in a single step to produce a meat mixture. In alternate embodiments of the present teachings, however, bacteria and a carbohydrate energy source are introduced to a smaller-piece-sized animal source of protein in discrete steps to produce a meat mixture.

Bacteria, or a bacteria/carbohydrate energy source mixture, may be prepared prior to step 106 as a “starter culture” that is introduced to a smaller-piece-sized animal source of protein. As used herein, the term “starter culture” means a composition of bacteria or a bacteria/carbohydrate energy source mixture that can serve in a beneficial role of promoting competitive exclusion of otherwise pathogenic bacteria inherent within a meat source. Accordingly, a starter culture, in subsequent steps (described below), facilitates lowering the pH value of a meat slurry, preventing growth of bacteria on a meat product, including food-borne pathogens, when a sufficiently low pH value is obtained.

In one embodiment of the present teachings, a starter culture is a lyophilized starter culture that includes freeze-dried bacteria in a dormant state. Bacteria in a lyophilized starter culture may be revitalized (i.e., resuscitated out of a dormant state and into a growing state) prior to step 106 to facilitate growth during a subsequent incubation step (i.e., step 110, described below). By way of example, a lyophilized bacteria (or a lyophilized bacteria/carbohydrate energy source mixture) starter culture may be revitalized by mixing with water (i.e., distilled water or water free of chlorine) at a ratio of water to starter culture, by weight, that is between about 15:1 and about 40:1, or more preferably, at least about 25:1, by weight. In order to facilitate revitalizing bacteria in a starter culture, the water/starter culture mixture may be mixed for between about 15 minutes and about 30 minutes, and/or at a temperature value that is between about 65° F. and about 75° F. It is noteworthy that heat is useful to help aid the growth of the starter culture. However, the amount and duration of heat is critical to assuring optimal fermentation occurs.

After revitalizing bacteria in a starter culture, the water/starter culture mixture may be introduced to a smaller-piece-sized reduced animal source of protein, according to step 106 of process 100. In certain embodiments of the present teachings, revitalizing bacteria may also be carried out in a starter cultures that is not lyophilized

In another embodiment of the present teachings, a starter culture comprising one or more bacteria and/or a carbohydrate energy source is prepared and stored as a frozen mass until it is used in step 106. The frozen starter culture is prepared by harvesting specific bacteria from culturing broth using filtration and/or centrifugation. The harvested cells are then mixed cold with a cryoprotectant (e.g., glycerol, milk solids, potato starch, dextrose, dimethyl sulfoxide (DMSO), propylene glycol, or sucrose). Prior to step 106, the frozen starter culture may be thawed to between about 50° F. and about 75° F., and then added to a smaller-piece-sized animal source of protein to produce a meat mixture. In other embodiments of the present teachings, the starter culture is introduced to a smaller-piece-sized animal source of protein without freezing, so long as the starter culture is prepared on or near the same day of preparation, to produce a meat mixture.

Prior to step 106, a meat mixture may delivered to a holding tank. In certain embodiments of the present teachings, a holding tank is one member selected from a group comprising a tote, a tanks, and a tanker truck.

Next, a step 108 includes adding water to a meat mixture to produce an activated meat mixture. An activated meat mixture may be thought of as a composition that comprises ingredients sufficient to facilitate fermentation of lactic acid producing bacteria during a subsequent incubating step (e.g., step 110, described below). In certain embodiments of the present teachings, however, a meat mixture produced according to steps 102-106 is sufficiently activated. In such embodiments, a meat mixture may be thought of as an activated meat mixture, and accordingly, step 108 is not needed. In other embodiments of the present teachings, water may be added at any time during a process of producing a meat slurry, so long as an activated meat mixture has a desired moisture content.

According to preferred embodiments of the present teachings, water is added to a meat mixture to produce an activated meat mixture that has a moisture content that is about 65%, by weight, and more preferably, about 74%, by weight. In certain embodiments of the present teachings, where a meat mixture includes a seafood animal source of protein, moisture content may be at least about 80%. Water activity of an activated meat mixture is sufficient to allow for fermentation of lactic acid producing bacteria, and preferably has a value that is at least about 0.95.

According to preferred embodiments of the present teachings, an activated meat mixture is in a substantially homogenized and/or substantially liquefied state. In certain embodiments of the present teachings, an activated meat mixture is pumpable.

It is noteworthy that a pH value of an activated meat mixture is greater than about 5.0, or in certain embodiments, greater than about 5.5, and thus is relatively unchanged from a pH value of an animal source of protein. As will be explained next, during incubation of an activated meat mixture, lactic acid producing bacteria produce lactic acid during fermentation conditions such that a pH value in the resulting meat slurry is reduced to a degree sufficient to inhibit growth and/or survival of certain spoilage microorganisms, including Salmonella, certain strains of E. coli, and certain yeasts and mold.

Next, a step 110 includes incubating an activated meat mixture to produce a meat slurry. According to certain embodiments of the present teachings, incubating an activated meat mixture is carried out at a temperature value that is between about 90° F. and about 125° F., and more preferably, between about 105° F. and about 125° F. Further, incubating an activated meat mixture is carried out for a time value that is at least about 4 hours, and more preferably, at least about 6 hours.

Incubating an activated meat mixture to produce a meat slurry, according to step 110, may be facilitated by at least one member selected from a group comprising a heat exchanger, an oven, a steam injection, a hot plate, a microwave, a jacketed cookers, a jacketed blenders, a steam oven, a infrared oven, a baking oven, a elements, a convection oven, a conduction oven, a preconditioner, a dehydrator, a pressure cooker, an impingement oven, a smokehouse, a smoker, a vacuum cooker and a double boiler. In one preferred embodiment of the present teachings, incubating an activated meat mixture to produce a meat slurry includes pumping an activated meat mixture through a heat exchanger.

According to preferred embodiments of the present teachings, step 110 produces a meat slurry that has a pH value that is less than about 4.7. The present teachings recognize that this lowering of pH, during incubation in step 110, from about 5.5 in an activated meat mixture, to less than about 4.7 in a meat slurry, is primarily due to the presence of lactic acid produced during fermentation of bacteria. Accordingly, an activated meat mixture includes bacteria in an amount sufficient to facilitate such lowering of pH value.

It is noteworthy that unlike conventional techniques, the present teachings do not disclose a step of adding acid, that is exogenous to lactic acid producing bacteria, to facilitate lowering of a pH value in a meat slurry. To the extent the present teachings contemplate or allow for the adding of exogenous acid, in one embodiment of the present teachings, this is limited to adding acid to a degree that lowers a pH value in a meat slurry by no more than about 0.2 units, prior to fermentation of lactic acid producing bacteria.

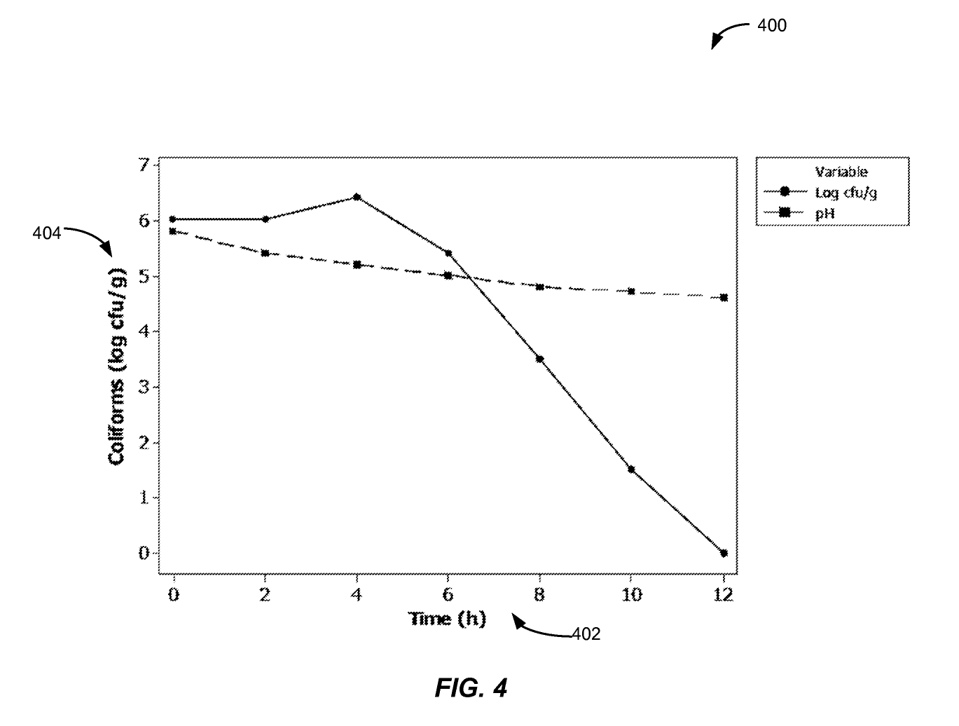

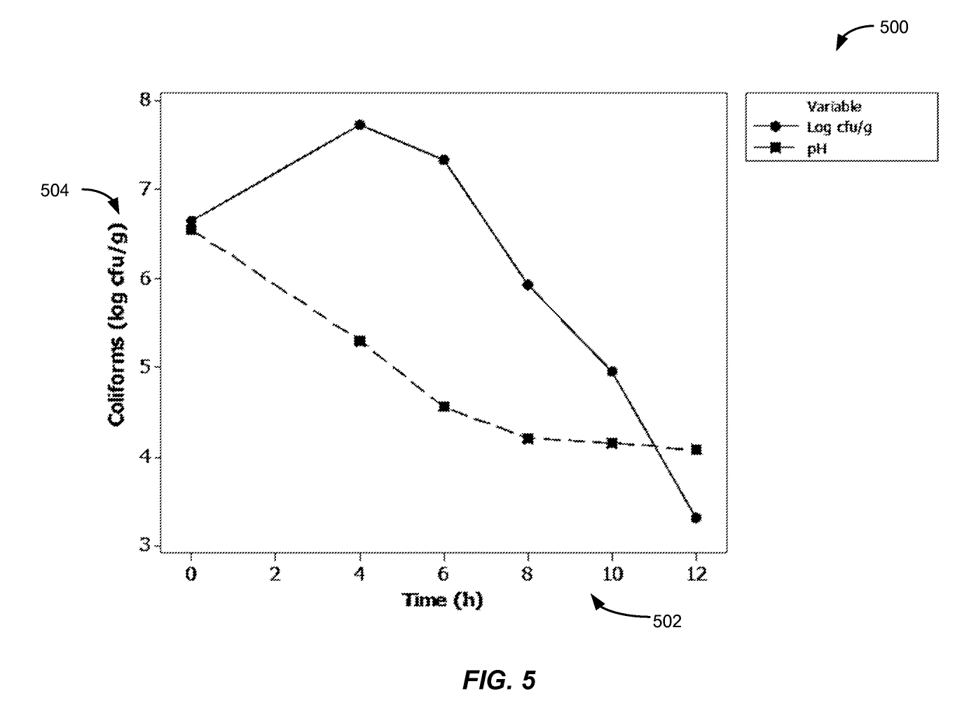

In certain embodiments of the present teachings, a meat slurry includes one or more types of lactic acid producing bacteria that are present in an amount that is at least about 1×10⁹ CFU/g of meat slurry. In other embodiments of the present teachings, a meat slurry includes one or more types of lactic acid producing bacteria in an amount that is at least about 1×10⁷ CFU/g of meat slurry. Lactic acid producing bacteria in a meat slurry may be in a state that is one member selected from a group comprising dormant, lag, living, logarithmic growth, stationary, and dead. Because lactic acid produced during fermentation lowers a pH value of a meat slurry to less than about 4.7, pathogen growth and/or survival is substantially inhibited (shown below with reference to FIGS. 4 and 5).

The present teachings further recognize that in addition to lactic acid, fermentation of bacteria during incubation in step 110 produces other bacterial metabolites or other fermentation byproducts that convey antimicrobial properties to a meat slurry. While several of these metabolites or fermentation byproducts are known to be odiferous compounds that may change the sensory characteristics of the meat, according to the present teachings, at least some of these facilitate reduction of spoilage bacteria, certain yeasts and molds, and other food-borne pathogens that cause the quality of the meat to degrade.

In certain embodiments of the present teachings, a meat slurry includes at least one lactic acid producing bacterial metabolite selected from a group comprising phenyllactic acid, 3-hydroxyphenyllactic acid, 4-hydroxyphenylactic acid, 3-hydroxy propanaldehyde, 1,2 propandiol, 1,3 propandiol, hydrogen peroxide, ethanol, acetic acid, carbon dioxide, carbonic acid, propanoic acid, butyric acid, cyclic dipeptides, cyclo(L-Phe-L-Pro), cyclo(L P-Traps-4-OH-L-Pro), 3-(R)-hydroxydecanoic acid, 3-hydroxy-5-cic dodecanoic acid, 3-(R)-hydroxy dodecanoic acid, and 3-(R)-hyroxytetradecanoic acid. In other embodiments of the present teachings, meat slurry includes a bacteriocin that is a lantibiotic (Class II) or a non-lantibiotic (Class II). In other embodiments of the present teachings, a bacteriocin in a meat slurry includes at least one member selected from a group comprising nisin A, nisin Z, nisin Q, nisin F, nisin U, nisin U2, salivarcin X, lacticin J46, lacticin 481, lacticin 3147, salivarcin A, salivarcin A2, salivarcin A3, salivarcin A4, salivarcin A5, salivarcin B, streptin, salivaricin A1, streptin, streptococcin A-FF22, BHT-Aa, BHT Ab, mutacin BNY266, mutacin 1140, mutacin K8, mutacin II, smbAB, bovicin HJ50, bovicin HC5, macedocin, plantaricin W, lactocin 5, cyctolysin, enterocin A, divercin V41, divercin M35, bavaricin, coagulin, pediocin PA-1, mundticin, piscicocin CS526, piscicocin 126/V1a, sakacin P, leucocin C, sakacin 5X, enterocin CRL35/mundticin, avicin A, mundticin I, enterocin HF, bavaricin A, ubericin A, leucocin A, mesentericin Y105, sakacin G, plantaricin 423, plantaricin C19, curvacin A/sakacin A, carnobacteriocin BM1, enterocin P, piscicoin V1b, penocin A, bacteriocin 31, bacteriocin RC714, hiracin JM79, bacteriocin T8, enterocin SE-K4, carnobacteriocin B2, SRCAM 1580, and Concensus.

According to another embodiment of the present teachings, a process for producing a meat slurry is disclosed. The process includes a first step of obtaining an animal source of protein having a certain pH value. This step is carried out in a substantially similar manner as described above with reference to step 102 of FIG. 1. Next, the process includes a step of reducing a piece size of the animal source of protein to produce a smaller-piece-sized animal source of protein having about the same pH value as, or a greater pH value than, the animal source of protein used in the previous step. This step is carried out in a substantially similar manner as described above with reference to step 104 of FIG. 1. Next, the process includes a step of introducing one or more types of lactic acid producing bacteria and at least one carbohydrate energy source to the smaller-piece-sized animal source of protein to produce a meat mixture having a pH value that is about the same pH value as, or a greater pH value than, the smaller-piece-sized animal source of protein used in the previous step. This step is carried out in a substantially similar manner as described above with reference to step 106 of FIG. 1. Next, the process includes a step of adding water to the meat mixture to produce an activated meat mixture having a pH value that is about the same pH value as, or a greater pH value than, the pH value of the meat mixture used in the previous step. This step is carried out in a substantially similar manner as described above with reference to step 108 of FIG. 1. Next, the process includes a step of incubating the activated meat mixture to produce a meat slurry that has a pH value that is less than the pH value of the activated meat mixture. In preferred embodiments of the present teachings, the pH value of the activated meat mixture (i.e., just prior to incubating) is greater than about 5.0, and the pH value of the meat slurry (i.e., after incubating), is less than about 4.7.

According to one embodiment of the present teachings, the one or more types of lactic acid producing bacteria are present on the meat mixture in an amount that is at least about 1×10⁷ colony forming units (“CFU”) of the one or more types of lactic acid producing bacteria per gram of meat mixture.

FIG. 2 is a flowchart for a process 200, according to one preferred embodiment of the present teachings, showing certain salient steps for producing a digested meat slurry. As explained below, producing a digested meat slurry is facilitated by treating a meat mixture with one or more proteolytic enzymes. As used herein, the term “proteolytic enzymes” refer to enzymes that are capable of breaking amino acid bonds within meat protein under sufficient digestion conditions. In such manner, proteolytic enzymes may serve to decrease the viscosity of a meat slurry and/or alter the sensory profile of the meat. Accordingly, the present teachings recognize that enzymatic digestion of meat facilitates homogeneity, flowability, liquefication, and/or pumpability of a meat slurry. In such manner, the present teachings promote finished product production processes that utilize continuous flow operations, where the metering in of a meat slurry is important for consistent application rates.

According to preferred embodiments of the present teachings, steps 202, 204, 210, 212, and 214 of FIG. 2 are substantially similar to their counterparts, steps 102, 104, 106, 108, 110, and 112, respectively, of FIG. 1. Process 200, however, includes additional steps that facilitate production of a digested meat slurry. To this end, after a smaller-piece-sized animal source of protein is produced using steps 202 and 204, a step 206 includes adding at least one proteolytic enzyme to the smaller-piece-sized animal source of protein to produce a pre-digested smaller-piece-sized animal source of protein.

In preferred embodiments of the present teachings, at least one proteolytic enzyme includes at least one member selected from a group comprising enzymes selected from a group comprising a protease, a peptidase, an exo-peptidase, and an endo-peptidase. In other embodiments of the present teachings, at least one proteolytic enzymes may be at least one member selected from a group comprising sulfhydryl protease, serine protease, alcalase, flavourzyme, protamex, liquipanol, papain, bromelain, ficin, an enzyme from Aspergillus oryzae, an enzyme from Bacillus subtilis var amyloliquifacians, a protease from Bacillus licheniformis, and pepsin from porcine and chicken stomachs. A proteolytic enzyme may be obtained in commercially available meat tenderizers, including those that serve as a source of bromelain (available from Parchem Fine & Specialty Chemicals located in New Rochelle, N.Y., from Nutriteck Bulk Products Division of Ultra Bio-Logics Inc. located in Rigaud, QC Canada, or from Lawry's Foods, LLC located in Sparks, Md., as found in as Adolph's® meat tenderizer), or those that serve as a source of papain as found in Kroger® Meat Tenderizer (available from Kroger®, located in Cincinnati, Ohio).

In one preferred embodiment of the present teachings, an amount of a papain in an activated meat mixture is one amount selected from a group comprising at least 500 Milk Clot Units per pound of meat (i.e., MCU/lb), at least 1,000 MCU/lb, at least 1500 MCU/lb, at least 2000 MCU/lb, and at least 5000 MCU/lb. In another preferred embodiment of the present teachings, an amount of bromelain in an activated meat mixture is one member selected from a group comprising at least about 200 MCU/lb, at least about 1000 MCU/lb, at least about 1400 MCU/lb, at least about 2000 MCU/lb, and at least about 5000 MCU/lb. In another preferred embodiment of the present teachings, an amount of ficin in an activated meat mixture includes one member selected from a group comprising at least about 200 MCU/lb, at least about 800 MCU/lb, at least about 1240 MCU/lb, at least about 2000 MCU/lb, at least about 2000 MCU/lb, and at least about 5000 MCU/lb. In another preferred embodiment of the present teachings, an activated meat mixture includes enzymes from Aspergillus in an amount that is one member selected from a group comprising at least about 1,000 Hemoglobin Units per pound of activated meat mixture (i.e., HUT/lb), at least about 2,000 HUT/lb, at least about 3600 HUT/lb, at least about 5000 HUT/lb, and at east about 10000 HUT/lb. In yet another preferred embodiment of the present teachings, an activated meat mixture includes enzymes from Bacillus in an amount that is one member selected from a group comprising at least about 100 Proteolytic Units per pound of activated meat mixture (i.e., expressed in units of “PC/lb”), at least about 300 PC/lb, at least about 670 PC/lb, at least about 1000 PC/lb, and at least about 2000 PC/lb.

Next, a step 208 includes digesting the pre-digested smaller-piece-sized animal source of protein to produce a digested animal source of protein. Digestion conditions (e.g., incubation temperatures and times) are sufficient to facilitate digestion of a smaller-piece-sized animal source of protein. According to preferred embodiments of the present teachings, digesting in step 208 is carried out by maintaining the temperature of a smaller-piece-sized animal source of protein at a value that is between about 130° F. and about 270° F., for a time that is between about 20 minutes and about 240 minutes.

After digesting in step 208, subsequent steps 210, which includes introducing one or more types of lactic acid producing bacteria and at least one carbohydrate energy source to the digested animal source of protein to produce a digested meat mixture, and 212, which includes incubating the digested meat mixture to produce a digested meat slurry, are carried out in a substantially similar manner as that described above with reference to steps 106 and 110, respectively, of FIG. 1. Though FIG. 2 shows digesting and incubating being carried out in separate steps, in certain embodiments of the present teachings, digesting and incubating are carried out simultaneously to produce a digested meat slurry. Further, to the extent additional water is required to produce a meat slurry, or an intermediate product, the present teachings recognize that additional water may be added at any time during process 200.

The physical form of a meat slurry or a digested meat slurry produced according to the present teachings may be thought of as being in a state that is at least one member chosen from a group comprising liquefied, emulsified, pumpable, and/or flowable. In one preferred embodiment of the present teachings, a meat slurry is in a semi-liquefied state. The present teachings recognize that several factors in the processes described herein facilitate production of a meat slurry in such a state or states. By way of example, reducing a piece-size of an animal source of protein releases water and facilitates hydrolysis of protein in meat in later steps, in part by providing more access to peptide bonds in a meat. In particular, piece-size reduction using fine grinding of a meat is useful to these ends. Water may be added during the process, making the meat slurry more fluid. Protein hydrolysis of a meat may be facilitated during an incubation step, where fermentation byproducts such as lactic acid, propionic acid, acetic acid, and butyric acid, are produced in the presence of heat. Likewise, digestion with proteolytic enzymes further facilitates breakdown of animal protein. In such manner, these factors produce a meat slurry that is in a semi-liquefied, emulsified, pumpable, and/or flowable form. A means of measuring the extent to which a meat slurry is in a pumpable form may include determining a flow rate of a meat slurry through a pipe. In certain embodiments of the present teachings, a meat slurry is capable of being pumped through a pump that has an internal diameter that is a value between about 2 inches and about 12 inches, preferably at a rate that is up to about 100,000 pounds of activated meat mixture per hour.

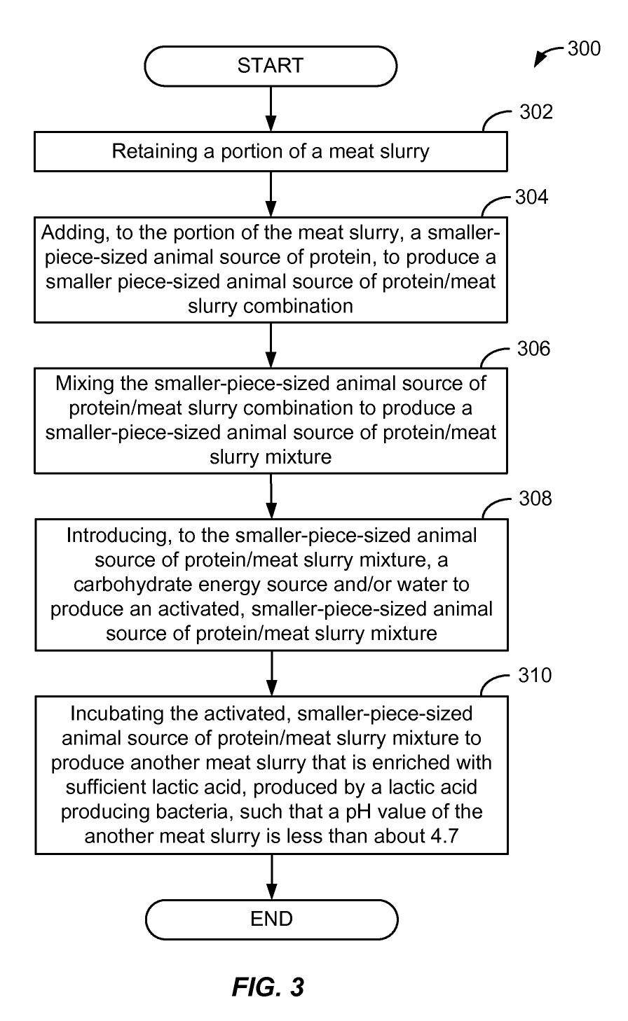

According to certain embodiments of the present teachings, a portion of a meat slurry or a digested meat slurry may be used to inoculate an animal source of protein (e.g., the smaller-piece-sized animal source of protein of FIG. 1 or FIG. 2) to produce another meat slurry batch. To this end, FIG. 3 shows certain salient steps of a process 300, according to one preferred embodiment of the present teachings, for producing another meat slurry using a meat slurry as an inoculant source. The present teachings recognize that such a process provides the advantage of carrying out multiple cycles of producing a meat slurry in a single container, thus reducing costs and increasing the efficiency of commercial meat slurry production.

Process 300 of FIG. 3 begins with a step 302, which includes retaining a portion of a meat slurry. According to preferred embodiments of the present teachings, a meat slurry that is retained was produced according to process 100 of FIG. 1 or process 200 of FIG. 2. Accordingly, the steps of process 300 are preferably carried out in the same container in which the meat slurry portion is retained, and a remainder portion of meat slurry that is removed may be delivered for storage or further processing, or it may be used as a food product.

Next, a step 304 includes adding, to the portion of the meat slurry, a smaller-piece-sized animal source of protein, to produce a smaller piece-sized animal source of protein/meat slurry combination. According to preferred embodiments of the present teachings, an animal source of protein is obtained in a substantially similar manner as that described above with reference to steps 102 and 202 of FIGS. 1 and 2, respectively, and is reduced to produce a smaller-piece-sized animal source of protein in a substantially similar manner as that described above with reference to steps 104 and 204 of FIGS. 1 and 2, respectively. The animal source of protein type may be the same as, or different than, the animal source of protein used to produce the meat slurry that is retained in step 302.

Next, a step 306 includes mixing the smaller-piece-sized animal source of protein/meat slurry combination to produce a smaller-piece-sized animal source of protein/meat mixture. Mixing is carried out to a degree that is sufficient to inoculate the smaller-piece-sized animal source of protein/meat slurry combination with viable lactic acid producing bacteria remaining in the retained meat slurry. While mixing in step 306 is shown as a separate step, according to certain embodiments of the present teachings, mixing may be carried out during the same time as subsequent steps 308 and 310 (described below).

Next, a step 308 includes introducing, to the smaller-piece-sized animal source of protein/meat slurry mixture, a carbohydrate energy source and/or water to produce an activated, smaller-piece-sized animal source of protein/meat slurry mixture. According to preferred embodiments of the present teachings, step 308 is carried out in a substantially similar manner as that described above with reference to steps 106 and 108 (with respect to the introduction of water) of FIG. 1 and step 210 of FIG. 2.

Next, a step 310 includes incubating the activated, smaller-piece-sized animal source of protein/meat slurry mixture to produce a new batch of meat slurry. Step 310 may be carried out in a substantially similar manner to that described above with reference to step 110 of FIG. 1 and step 210 of FIG. 2. The new batch of meat slurry is enriched with an amount of lactic acid, produced during fermentation of lactic acid producing bacteria, that is sufficient to lower a pH value of the meat slurry to less than about 4.7. The present teachings recognize that a portion of the meat slurry produced according to process 300 may be retained and used to carry out an additional cycle of meat slurry production, according to the embodiment of process 300. In such manner, multiple cycles of meat slurry production may be carried out, providing the advantages of increased efficiency and lower costs of meat slurry production. In certain embodiments of the present teachings, a pH value of a meat slurry may be monitored, and if it below a threshold pH value (e.g., a pH value of 4.7), then the process may be repeated to produce another meat slurry according to the present teachings.

Meat slurry produced according to the present teachings may be used in several ways. In certain embodiments of the present teachings, a meat slurry may be ingested as a food product or may be included as a meat product in a pet food or a human food. In one preferred embodiment of the present teachings, a meat slurry is added to a pet food that is at least one member selected from a group comprising extruded, expanded, retorted, baked, injection molded, chubbs, chub, refrigerated, frozen, and a pet food treat. In another preferred embodiment of the present teachings, a pet food is dried to produce a rendered meal. Several examples of such uses in human and pet food are shown below.

Though not required to carry out the present teachings, one or more palatants, digests, or flavors may be added to a pet or human food that comprises a meat slurry so as to facilitate longer-term storage while minimizing degradation of food quality (e.g., by production of unpleasant odors).

Meat slurry produced according to the present teachings provides several advantages. By way of example, due to the presence in a meat slurry of lactic acid that produces a pH of less than or equal to about 4.7, as well as other bacterial metabolites that inhibit spoilage organisms such as Staphylococcus aureus, Clostridium botulinum, and Clostridium perfringens, and pathogen growth, the shelf-life of food products that include a meat slurry as at least one component is greatly extended. As used herein, the term “shelf life” refers to the length of time that a meat slurry can be maintained at a pH value that is less than about 5.0 and not smell of off-odors or decomposing odors. An off or decomposing odor can be demonstrated by allowing an unfermented meat slurry in a container maintained at about 90° F. to about 125° F. for at least about 4 to about 12 hours. It is noteworthy that while a pH value of less than about 5.7 will provide some degree of preservation to a food product, this does not make a food product shelf-stable.

According to preferred embodiments of the present teachings, a meat slurry has a shelf-life, at conditions that do not require refrigeration or freezing, that is at least one duration selected from a group comprising at least about 14 days, at least about 4 months, at least about 10 months, and greater than ten months. In one embodiment of the present teachings, a meat slurry is capable of being stored at a temperature value that is between about 55° F. and about 85° F. and for a time value that is between about 10 days and 90 days. In another embodiment of the present teachings, the time value is between about 90 days and about 24 months, and in yet another embodiment of the present teachings, the time value is greater than about 24 months, such that after said being stored, the meat slurry is fit for consumption by a human or an animal. Further, a meat slurry or a food product mixed with a meat slurry may be frozen and retail substantially all pathogen-inhibiting, preservative-extending, and health-promoting attributes.

Due to its enhanced shelf-life, a meat slurry remains edible in storage conditions (e.g., relatively higher temperatures) that would otherwise promote spoilage bacteria, certain yeasts, certain molds, and pathogen growth. Similarly, to the extent refrigeration or freezing of food products is necessary to maintain the stability of meat products that do not include lactic acid and other bacterial metabolites that inhibit growth of food-borne pathogens, the present teachings provide the advantage of reduced costs, such as the reduction or elimination of refrigeration or freezing to maintain an extended shelf-life. In other words, the extended shelf-life of a meat slurry provides the further advantage of greater ease and flexibility in storing and handling a meat slurry.

The present teachings further recognize that due to the presence of natural ingredients to promote an extended shelf-life, food products that include a meat slurry do not require, or require less, preservatives (e.g., salt, tetra-sodium polyphosphate, humectants, sugars, glycerin, nitrites, nitrates, propylene glycol, phosphoric acid, potassium sorbate, sorbic acid, citric acid, lactic acid, acetic acid, propionic acid, para amino benzoic acid, parabens, sodium benzoate, or benzoic acid). By way of example, acids produced during fermentation, including lactic acid, are more easily metabolized than mineral acids, which may be used to facilitate preservation of food products but which also promote negative impacts on human and animals. Further, not only does the absence of such preservatives in a food product reduce costs, it also provides a healthier meat product for consumption, and provides a simpler and more natural ingredient lists for consumer appeal consistent with consumer trends.

The present teachings further recognized that as part of the fermentation process, organic acids such as lactic acid, acetic acid, propionic acid, and butyric acid may be produced from the added bacterial cultures. These organic acids have been shown to provide energy for the cells lining of the intestine. These organic acids may have other additional benefits, including improved mineral (such as calcium) absorption, reduced likelihood of polyp formation in the colon, reduced likelihood of intestinal infections such as Clostridium, Staphylococcus, Escherichia, and Salmonella, enhanced recovery from intestinal surgeries, reduced incidence of intestinal colitis, and reduced synthesis of cholesterol and decreased formation of low density lipoprotein (LDL) cholesterol and triglycerides that reduces the risk of atherosclerosis. Alternatively, inorganic acids such as phosphoric acid are used in relatively high abundance in beverages. Excessive levels of phosphorus may lead to osteoporosis, accelerated renal failure and is known to erode the enamel on teeth. In sum, the use of organic acids as part of the food preservation process is preferred over inorganic acids such as phosphoric acid.

The present teachings further recognize the advantage of producing a food product that has certain health benefits due not only to the absence of preservatives, but also due to the presence of beneficial bacteria. By way of example, a meat slurry that includes one or more of the lactic acid producing bacterial strains disclosed herein may be used to enhance intestinal health in general, and specifically, of individuals with inflammatory bowel disease (IBD), irritable bowel syndrome (IBS), short bowel syndrome, short bowel resection, non-specific diarrhea, intestinal resection, ulcerative colitis, celiac disease, and Crohns disease. Actions of the bacteria themselves, or metabolites produced during fermentation, such as organic acids, short-chain fatty acids, acetate, propionate, butyrate, lactate, or bacteriocins, are known to improve gut bacterial ecology and immune response of the intestinal tract. While various specific embodiments have been described in detail herein, the present disclosure is intended to cover various different combinations of the disclosed embodiments and is not limited to those specific embodiments described herein. The various embodiments of the present disclosure may be better understood when read in conjunction with the following representative examples. The following representative examples of the present teachings in use are included for purposes of illustration and not limitation.

### EXAMPLES

### Example 1

### Compositions and Methods of Making a Chicken Slurry

According to the embodiment of Example 1, a composition of an activated meat mixture used to produce a chicken slurry, as would occur in a typical slaughterhouse facility, is shown. The composition of the activated meat mixture is set forth in Table 1. In this example, mechanically deboned chicken was ground and emulsified to form a piece-size-reduced chicken meat. The apple juice concentrate was added to produce about a 5.5%, by weight, mixture. A starter culture, comprising Pediococcus acidilactici and Pediococcus pentosaceus (Bactoferm LHP, Chr. Hansen, Milwaukee, Wis.) and distilled water (about 42 g bacteria/100 g water), was treated for 30 minutes at ambient (about 65° F. to about 75° F.) temperatures to rejuvenate the bacteria. The meat mixture was inoculated with the rejuvenated starter culture (about 142 g starter culture/500 pounds of meat mixture) at a level sufficient to produce about 1×10⁷ CFU of bacteria per gram of meat mixture. The temperature of the activated meat mixture was brought to a value that is between about 104° F. and about 110° F., and then incubated at about the same temperature for between about 8 and about 14 hours, to produce a meat slurry. The resulting meat slurry had a pH value of about 4.6.

TABLE 1
Activated Chicken Mixture Composition Used to
Produce a Chicken Slurry

| Ingredient | Approximate Percent (by Weight) |
|---|---|
| Mechanically deboned chicken | 94.4 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ CFU/g of mechanically deboned chicken meat.

### Example 2

### Compositions and Methods of Making a Chicken Slurry

According to the embodiment of Example 2, an activated meat mixture that is treated to produce a chicken slurry comprises mechanically deboned chicken mixed with dextrose and bacteria. Preparation and treatment of the compositions of Example 2 were carried out in a substantially similar manner as that described above with reference to Example 1. In Example 2, however, dextrose (2%, by weight), instead of apple juice concentrate, is used as a carbohydrate energy source in the activated meat mixture. The composition of the activated meat mixture is set forth in Table 2. After incubation under the same parameters as set forth in Example 1, the resulting meat slurry had a pH value of about 4.6.

TABLE 2
Activated Chicken Mixture Composition Used to
Produce a Chicken Slurry

| Ingredient | Approximate Percent by Weight |
|---|---|
| Mechanically deboned chicken | 96.9 |
| Dextrose | 2.0 |
| Starter Culture* | 0.0626 |

*Starter Culture contains sufficient Pediococcus acidilactici and Pediococcus pentosaceus to provide 1 × 10⁷ CFU/g of mechanically deboned chicken meat.

### Example 3

### Composition and Method of Making a Digested Chicken Slurry

According to the embodiment of Example 3, an activated meat mixture that is treated to produce a digested chicken slurry comprises mechanically deboned chicken mixed with dextrose, bacteria, and proteolytic enzymes. Preparation and treatment of the compositions of Example 3 were carried out in a substantially similar manner as that described above with reference to Example 2. In Example 2, however, the activated meat mixture also included proteolytic enzymes papain and bromelain. The composition of the activated meat mixture is set forth in Table 3.

Commercially available meat tenderizers were used as sources of papain and bromelain. The proteolytic enzymes were added to provide about 2.5 grams of Adolph's® Tenderizer for each pound of meat and 2.5 grams of Kroger® meat tenderizer for each pound of meat. After treatment under the same conditions as described in Example 2, the resulting digested meat slurry had a pH of about 4.6. It is noteworthy that in Example 3, incubating bacteria and digesting meat were carried out in a single heat treatment step.

TABLE 3
Activated Chicken Mixture Composition Used to
Produce a Chicken Slurry

| Ingredient | Approximate Percent by Weight |
|---|---|
| Mechanically deboned chicken | 94.4 |
| Apple Juice Concentrate | 5.5 |
| Starter Culture* | 0.0626 |
| Proteolytic Enzymes** | 0.011 |

*Starter Culture contains sufficient Pediococcus acidilactici and Pediococcus pentosaceus to provide 1 × 10⁷ CFU/g of mechanically deboned chicken meat.
**Proteolytic enzymes include bromelain and papain provided by 2.5 grams of Adolph's ® Tenderizer for meat (papain) added to each pound of meat and 2.5 grams of Kroger ® meat tenderizer (bromelain) added to each pound of meat.

### Example 4

### Composition and Method of Making a Digested Beef Slurry

According to the embodiment of Example 4, an activated meat mixture that is treated to produce a digested beef slurry comprises beef pieces mixed with dextrose, bacteria, and proteolytic enzymes. Preparation and treatment of the compositions of Example 4 were carried out in a substantially similar manner as described above with reference to Example 3. In Example 3, however, the activated meat mixture included beef pieces (not mechanically deboned chicken) as an animal source of protein. After incubation, the resulting digested beef slurry had a pH of about 4.6.

TABLE 4
Activated Beef Mixture Composition Used to
Produce a Beef Slurry

| Ingredient | Approximate Percent by Weight |
|---|---|
| Beef pieces | 94.4 |
| Apple Juice Concentrate | 5.5 |
| Starter Culture* | 0.0626 |
| Proteolytic Enzymes** | 0.011 |

*Starter Culture contains sufficient Pediococcus acidilactici and Pediococcus pentosaceus to provide 1 × 10⁷ CFU/g of mechanically deboned chicken meat.
**Proteolytic enzymes include bromelain and papain provided by 2.5 grams of Adolph's ® Tenderizer for meat (bromelain) added to each pound of meat and 2.5 grams of Kroger ® meat tenderizer (papain) added to each pound of meat.

### Example 5

### Extension of Shelf-Life for a Chicken Slurry

According to the embodiment of Example 5, an activated meat mixture was prepared and treated in a manner substantially similar as described in the embodiment of Example 3, to produce a chicken slurry. The composition of the activated meat mixture used to produce the chicken slurry is shown in Table 5. The chicken slurry was then stored at about 100° F. for about five days, and then at about 60° F. for about another seven days. At the end of about 12 days the chicken slurry did not have a bad aroma. As a result, the chicken slurry had a shelf-life of at least about 12 days.

TABLE 5
Activated Chicken Mixture Composition Used to
Produce a Chicken Slurry

| Ingredient | Approximate Percent by Weight |
|---|---|
| Mechanically Deboned Chicken | 94.4 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ CFU/g of mechanically deboned chicken meat.

### Example 6

### Reduction of Pathogen Growth in a Beef Slurry

According to the embodiment of Example 6, an activated meat mixture was prepared and treated in a manner substantially similar to that described in Example 5. In Example 6, however, ground-up beef (instead of mechanically deboned chicken), having piece sizes less than about ¼ inch, were used as an animal source of protein. The composition of the activated meat mixture is set forth in Table 6. The resulting beef slurry was vacuum packaged and incubated at about 110° F. for about 12 hours. At every 2-hour interval, the bacterial count (CFU/g) and pH were assessed.

To this end, FIG. 4 shows a line graph 400 where values of both pH (shown with square plotted points) and bacterial counts (shown with circular plotted points) are plotted on a Y-axis (denoted by reference numeral 404), and values of time are plotted on an X-axis (denoted by reference numeral 402), during incubation that produces a meat slurry. Time of incubation is expressed in units of hours. Bacterial counts are expressed in units of log CFU/g, where log CFU/g represents the logarithmic value of colony forming units of Salmonella surrogates per gram of meat slurry. As used herein, “Salmonella surrogates” refers to surrogates of Salmonella.

According to the embodiment of Example 6, bacterial counts of Enterobacter aerogenes ATCC 13048 and Escherichia coli ATCC 8739 are shown. The present teachings recognize that Enterobacter aerogenes ATCC 13048 and Escherichia coli ATCC 8739 are surrogates for Salmonella which is a food-borne pathogen. Bacterial counts may be thought of as expressing the amount of live bacteria present in the beef slurry.

As shown in FIG. 4, surrogate Salmonella cultures die off starting at 4 hours until there were no viable Salmonella surrogates at about 12 hours. As the level of Salmonella surrogates at 0 hours was over 1×10⁶ CFU/g, FIG. 4 shows that the culturing process reduced the survival of pathogenic organisms by more than 6 logs at the end of the 12-hour incubation period, with a rapid drop in viable Salmonella surrogates beginning at about 4 hours of incubation. Further, the pH of the mixture continued to decline through 12 hours of incubation, where pH is about 4.7. At the end of about 12 hours the cultured meat slurry did not have a bad aroma.

TABLE 6
Meat Slurry Composition

| Ingredient | Approximate Percent by Weight |
|---|---|
| Ground up beef | 94.4 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ CFU/g of ground up beef.

### Example 7

### Maintaining Reduced Levels of Pathogens in a Beef Slurry

According to the embodiment of Example 7, maintaining reduced levels of pathogens in a meat slurry is shown. In Example 7, a meat slurry sample was generated in a substantially similar manner as explained in Example 6. The meat slurry sample was stored for about four months at temperatures between about 60° F. and about 75° F. After four months, the meat slurry sample did not have a bad aroma and had a pH value of about 4.55.

### Example 8

### Reduction of Pathogens in a Pork Slurry

According to the embodiment of Example 8, reduction of pathogen survival in a pork slurry is shown. Preparation of the activated pork mixture used in Example 8 was carried out in a manner substantially similar to that explained above in Example 6. In Example 8, however, the animal source of protein is a ground-up pork (instead of ground-up beef,) with a piece size of about 0.25 inches. The composition of the activated pork mixture is set forth in Table 7.

As in Example 6, the resulting pork slurry was vacuum packaged and incubated at 110° F. for 12 hours. At every 2 hour interval, the bacterial count (CFU/g) and pH was assessed to determine pathogen survival during incubation that produces a pork slurry. To this end, FIG. 5 shows a line graph 500 where values of both pH (shown with square plotted points) and pathogen survival (shown with circular plotted points) are plotted on a Y-axis (denoted by reference numeral 504), and values of time are plotted on a X-axis (denoted by reference numeral 502). The amount of pathogen survival is expressed in units of log CFU/g, where log CFU represents the logarithmic value of colony forming units of Salmonella surrogates per gram of meat slurry. Time is expressed in units of hours.

As shown in FIG. 5, active growth of the bacterial culture is shown until about 4 hours, after which bacterial viability rapidly declined until being nearly 1×10³ CFU/g at 12 hours. As the highest level of Salmonella surrogates was over 1×10⁷ CFU/g, the culturing process reduced the pathogenic organisms by more than about 4 logs. The pH of the mixture rapidly declines until about 8 hours and then gradually declined until about 12 hours, where pH is about 4.0. At the end of about 12 hours the cultured meat slurry did not have a bad aroma.

TABLE 7
Activated Pork Slurry Mixture Used to Generate a Pork Slurry

| Ingredient | Approximate Percent by Weight |
|---|---|
| Ground up pork | 94.4 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ CFU/g of ground pork meat.

### Example 9

### Maintaining Reduced Levels of Pathogens in a Pork Slurry

According to the embodiment of Example 9, a pork slurry had a shelf-life of at least four months. In Example 9, the pork slurry of Example 8 was stored at a temperature between about 60° F. and about 75° F. for about four months. After about four months the cultured meat slurry did not have a bad aroma and was at a pH of about 4.55. As a result, this incubated mixture of meat slurry, apple juice concentrate, and starter culture demonstrated a shelf-life of at least about four months.

### Example 10

### Maintaining Reduced Levels of Spoilage Organisms in a Chicken Slurry

According to the embodiment of Example 10, a chicken slurry having a shelf-life of at least about 18 days is shown. In Example 10, an activated meat mixture was prepared in a manner substantially similar to that described above with reference to Example 3. The composition of the activated chicken mixture that produces the chicken slurry is set forth in Table 8. The resulting chicken slurry was packaged for culturing into plastic tubs and covered with plastic lids. Chicken slurry was incubated at about 100° F. for about 12 hours, then stored at about 100° F. for about 5 days, and at about 60° F. for about an additional 13 days. After about 18 days, the chicken slurry did not have a bad aroma and was at a pH of about 4.7. As a result, this incubated mixture demonstrated a shelf-life of at least about 18 days.

TABLE 8
Activated Chicken Mixture Composition Used to
Produce a Chicken Slurry

| Ingredient | Approximate Percent by Weight |
|---|---|
| Mechanically de-boned chicken | 94.4 |
| Apple Juice Concentrate | 5.5 |
| Starter Culture* | 0.0626 |
| Proteolytic enzymes** | 0.02 |

*Starter Culture contains sufficient Pediococcus acidilactici and Pediococcus pentosaceus to provide 1 × 10⁷ CFU/g of mechanically de-boned chicken.
**Proteolytic enzymes include bromelain and papain provided by 4.5 grams of Adolph's ® Tenderizer for meat (bromelain) and 4.5 grams of Kroger ® meat tenderizer (papain) added to each pound of meat.

### Example 11

### Maintaining Reduced Levels of Spoilage Organisms in a Digested Chicken Slurry

According to the embodiment of Example 11, maintaining reduced levels of spoilage organisms in a digested chicken slurry is shown. In Example 11, a composition for and treatment of a digested activated chicken mixture used to produce a digested chicken slurry is substantially similar to preparation and treatment samples from Example 3. In Example 11, however, an animal source of protein includes equal parts, by weight, of mechanically deboned chicken and whole chicken meat (as opposed to only mechanically deboned chicken). Samples of chicken slurry were prepared with both proteolytic enzymes (bromelain and papain) and without proteolytic enzymes were evaluated. The composition of the cultured meat slurry is set forth in Table 9.

The resulting chicken slurry samples were packaged plastic tubs and covered with plastic lids. Both types of chicken slurry samples were incubated at about 100° F. for about 8 hours, then stored at about 45° F. for an additional 21 days. After about 21 days, the aroma of both digested and undigested samples of chicken slurry were evaluated. Both samples did not have a bad aroma after about 21 days, and both had a pH value that was less than about 4.7. As a result, both incubated mixtures demonstrated a shelf-life of at least about 21 days.

TABLE 9
Activated Chicken Mixture Compositions Used to Produce
Digested and Undigested Chicken Slurries

| Ingredient | Approximate Percent by Weight |
|---|---|
| Mechanically de-boned chicken | 97.9 |
| and Whole Chicken Meat | |
| Dextrose | 2.0 |
| Starter Culture* | 0.0626 |
| Proteolytic enzymes (if added)** | 0.02 |

*Starter Culture contains sufficient Pediococcus acidilactici and Pediococcus pentosaceus to provide 1 × 10⁷ CFU/g of mechanically de-boned chicken.
**Proteolytic enzymes include bromelain and papain provided by about 4.5 grams of Adolph's ® Tenderizer for meat (bromelain) added to each pound of meat and about 4.5 grams of Kroger ® meat tenderizer (papain) added to each pound of meat.

### Example 12

### Sustainable Inoculation Practice within a Slaughterhouse

According to the embodiment of Example 12, previous partial batches of a meat slurry are used to inoculate fresh meat pieces to sustain a live culture of bacteria in a continuous process for up to about two weeks. In this example, water is heated to about 90° F. and about 1×10⁷ CFU/g of bacterial culture (Pediococci acidilactici and Pediococci pentosaceus) is added to create a starter culture. The starter culture is allowed to equilibrate for at least about 15 min before injection. After sufficient equilibration time, a sufficient amount of starter culture is added into about 4000 lbs of meat (in the form of beef trimmings from the slaughter of beef) to provide about 1×10⁷ CFU of bacteria per gram of meat. A 1% dextrose concentration in the meat is also obtained by adding about 40 pounds of dextrose to the 4000 pounds of meat. The bacteria are allowed to ferment within the meat for at least about 6 hours and for sufficient time to obtain a pH of below about 4.7. After obtaining a pH of below about 4.7, up to about 75% of the meat is removed from the bin holding the meat. The removed meat is sent to pet food manufacturers for incorporation into pet food. The remaining portion of the meat is kept in the bin while new pieces of meat obtained from beef trimmings during the slaughter of beef are added to the bin. The already-fermented beef is mixed with the fresh beef, and the pH of the mixture is monitored hourly. Initially, after introducing the fresh beef, the pH rises above about 4.7. After sufficient fermentation time, the pH has dropped below about 4.7. Once pH is below about 4.7 up to about 75% of the meat mixture is again removed for shipment to pet food manufacturing plants for incorporation into pet food. This process is repeated over the course of two weeks. After two weeks, the meat containing bin is completely emptied, cleaned, and sanitized and the process re-started for the next two-week cycle.

### Example 13

### Bacterial Culture Addition Into a Meat Spread

According to the embodiment of Example 13, a live culture of bacteria is mixed into a minced, cooked meat spread. In Example 13, water is heated to about 90° F., and about 1×10⁷ CFU/g of bacterial culture (Pediococci acidilactici and Pediococci pentosaceus) is added to create an activated starter culture. The starter culture is allowed to equilibrate for at least about 15 minutes before about 1% dextrose is added to create an activated, enriched starter culture. The activated, enriched starter culture is mixed into a minced, cooked meat spread to enable stability and lessen the growth of food-borne pathogens. The meat spread is served as a spread for used in topping bread as an additional option or alternative to sliced meats, cheeses or peanut butter. The meat spread has the unusual property of being shelf-stable in ambient storage environments and is resistant to food-borne pathogens, as it has been inoculated with the activated, enriched starter culture.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A meat slurry composition, comprising:
an animal source of protein;
one or more types of lactic acid producing bacteria;
lactic acid;
water; and
wherein said meat slurry composition is in a semi-liquefied state, and said lactic acid is produced by said one or more types of lactic acid producing bacteria in an amount that is sufficient to maintain a pH value of said meat slurry composition at less than about 4.7.

2. The composition of claim 1, wherein said semi-liquefied state includes a largest piece-size of a substantial amount of said animal source of protein that does not exceed a dimension that is about 20 mm.

3. The composition of claim 2, wherein said largest piece-size of a substantial amount of said animal source of protein does not exceed a dimension that is about 10 mm.

4. The composition of 1, wherein said animal source of protein includes at least one member selected from a group comprising chicken, turkey, poultry, beef, pork, lamb, goat, buffalo, kangaroo, rabbit, and venison.

5. The composition of claim 1, wherein said animal source of protein includes at least one member selected from a group comprising a gullet, a trachea, a liver, a heart, a kidney, an intestine, a stomach, cartilage, a bone, and skeletal muscle tissue.

6. The composition of claim 1, wherein said animal source of protein is in a state that is one member selected from a group comprising raw, pasteurized, seared, poached, blanched, braised, cooked, and uncooked.

7. The composition of claim 1, wherein said meat slurry composition has a moisture content that is at least 65%.

8. The composition of claim 1, wherein said meat slurry composition has a moisture content that is at least 74%.

9. The composition of claim 1, wherein said meat slurry composition has a moisture content that is at least about 80%.

10. The composition of claim 1, wherein said one or more types of lactic acid producing bacteria is in a state that is one member selected from a group comprising dormant, lag, living, logarithmic growth, stationary, and dead.

11. The composition of claim 1, further comprising at least one antimicrobial lactic acid producing bacteria metabolite selected from a group comprising phenyllactic acid, 3-hydroxyphenyllactic acid, 4-hydroxyphenylactic acid, 3-hydroxy propanaldehyde, 1,2 propandiol, 1,3 propandiol, hydrogen peroxide, ethanol, acetic acid, carbon dioxide, carbonic acid, propanoic acid, butyric acid, cyclic dipeptides, cyclo(L-Phe-L-Pro), cyclo(L P-Traps-4-OH-L-Pro), 3-(R)-hydroxydecanoic acid, 3-hydroxy-5-cic dodecanoic acid, 3-(R)-hydroxy dodecanoic acid, and 3-(R)-hyroxytetradecanoic acid.

12. The composition of claim 1, further comprising at least one bacteriocin that is a lantibiotic (Class II) or a non-lantibiotic (Class II).

13. The composition of claim 1, further comprising at least one bacteriocin selected from a group comprising nisin A, nisin Z, nisin Q, nisin F, nisin U, nisin U2, salivarcin X, lacticin J46, lacticin 481, lacticin 3147, salivarcin A, salivarcin A2, salivarcin A3, salivarcin A4, salivarcin A5, salivarcin B, streptin, salivaricin A1, streptin, streptococcin A-FF22, BHT-Aa, BHT Ab, mutacin BNY266, mutacin 1140, mutacin K8, mutacin II, smbAB, bovicin HJ50, bovicin HC5, macedocin, plantaricin W, lactocin 5, cyctolysin, enterocin A, divercin V41, divercin M35, bavaricin, coagulin, pediocin PA-1, mundticin, piscicocin CS526, piscicocin 126/V1a, sakacin P, leucocin C, sakacin 5X, enterocin CRL35/mundticin, avicin A, mundticin I, enterocin HF, bavaricin A, ubericin A, leucocin A, mesentericin Y105, sakacin G, plantaricin 423, plantaricin C19, curvacin A/sakacin A, carnobacteriocin BM1, enterocin P, piscicoin V1b, penocin A, bacteriocin 31, bacteriocin RC714, hiracin JM79, bacteriocin T8, enterocin SE-K4, carnobacteriocin B2, SRCAM 1580, and CONCENSUS.

14. The composition of claim 1, further comprising one or more proteolytic enzymes, wherein said animal source of protein is digested by said one or more proteolytic enzymes.

15. The composition of claim 14, wherein at least one of said one more proteolytic enzymes is selected from a group comprising a protease, peptidase, an exo-peptidase, and an endo-peptidase.

16. The composition of claim 14, wherein at least one of said one or more proteolytic enzymes includes at least one member chosen from a group comprising sulfhydryl protease, serine protease, alcalase, flavourzyme, protamex, liquipanol, papain, bromelain, ficin, an enzyme from Aspergillus oryzae, an enzyme from Bacillus subtilis var amyloliquifacians, a protease from Bacillus licheniformis, and pepsin from porcine and chicken stomachs.

17. The composition of claim 1, wherein said meat slurry composition is in a state that is one member chosen from a group comprising liquefied, pumpable, homogenous, flowable, and emulsified.

18. The composition of claim 17, wherein said pumpable includes capable of being pumped through a through a pipe that has an internal diameter that is a value between about 2 inches and about 12 inches, at a flow rate that is value up to about 100,000 pounds of said activated meat mixture per hour.

19. The composition of claim 1, wherein said meat slurry composition is capable of substantially inhibiting growth and/or survival of at least one pathogenic or spoilage microorganism.

20. The composition of claim 19, wherein said at least one pathogenic or spoilage microorganism includes a yeast or a mold.

21. An activated meat mixture composition, comprising:
an animal source of protein;
one or more types of lactic acid producing bacteria;
at least one carbohydrate energy source;
water; and
wherein said animal source of protein is in a substantially piece-size-reduced state, said composition has a pH value that is greater than about 5.0, and said one or more types of lactic acid producing bacteria is present on said activated meat mixture in an amount that is at least about 1×10⁷ colony forming units (“CFU”) of bacteria per gram of said activated meat mixture composition.

22. The composition of claim 21, wherein said activated meat mixture composition has a pH value that is greater than about 5.5.

23. The composition of claim 21, wherein a largest piece-size of said piece-size-reduced state of said animal source of protein does not exceed a dimension that is about 20 mm.

24. The composition of claim 21, wherein a largest piece-size of said piece-size-reduced state of said animal source of protein does not exceed a dimension that is about 10 mm.

25. The composition of claim 21, wherein said animal source of protein is selected from one or more of the group comprising pasteurized, poached, blanched, braised and seared.

26. The composition of claim 21, wherein said a least one type of lactic acid producing bacteria includes at least one member selected from a group comprising Pediococcus acidilactici, Pediococcus pentosaceus, Lactococcus lactis, Lactococcus cremoris, Lactobacillus delbruckii var bulgaricus, Lactobacillus plantarum, Lactobacillus pentosum, Streptococcus thermophilus, Lactobacillus sakei, and Lactobacillus curvatus.

27. The composition of claim 26, wherein said one or more types of lactic acid producing bacteria includes Pediococcus acidilactici and Pediococcus pentosaceus.

28. The composition of claim 21, wherein said one or more types of lactic acid producing bacteria is present in said composition in an amount that is about 1×10⁴ CFU of said one or more types of lactic acid producing bacteria per gram of said activated meat mixture composition.

29. The composition of claim 21, wherein said one or more types of lactic acid producing bacteria is present on said composition in an amount that is about 1×10⁹ CFU of said one or more types of lactic acid producing bacteria per gram of said activated meat mixture composition.

30. The composition of claim 21, wherein said lactic acid producing bacteria is capable of fermenting to produce lactic acid in an amount that is sufficient to lower a pH value of said activated meat mixture to less than about 4.7.

31. The composition of claim 21, wherein said at least one carbohydrate energy source includes at least one member selected from a group comprising apple juice, apple juice concentrate, dextrose, dextrose monohydrate, dextrose hydride, grape sugar, D-glucose, corn sugar, corn syrup solids, hydrolyzed corn syrup, levulose, glucose, fructose, galactose, xylose, ribose, mannose, sorbose, high fructose corn syrup, apple pulp, honey, sugar, maple syrup, pear juice, grape juice, orange juice, fruit juice, and lactose.

32. The composition of claim 21, wherein said activated meat mixture composition includes between about 2.5 mg and about 50 mg of said at least one carbohydrate energy source per gram of said activated meat mixture.

33. The composition of claim 21, wherein said activated meat mixture composition includes between about 10 mg and about 20 mg of said at least one carbohydrate energy source per gram of said composition.

34. The composition of claim 21, wherein said activated meat mixture composition has a water activity value that is at least about 0.95.

35. The composition of claim 21, wherein said activated meat mixture composition has a moisture content that is at least about 65% by weight.

36. The composition of claim 21, wherein said activated meat mixture composition has a moisture content that is at least about 74% by weight.

37. The composition of claim 21, wherein said activated meat mixture composition has a moisture content that is at least about 80% by weight.

38. The composition of claim 21, further comprising at least one proteolytic enzyme.

39. The composition of claim 38, wherein said at least one proteolytic enzyme includes at least one member selected from a group comprising a protease, a peptidase, an exo-peptidase, and an endo-peptidase.

40. The composition of claim 38, wherein said at least one proteolytic enzyme includes at least one member selected from a group comprising sulfhydryl protease, serine protease, alcalase, flavourzyme, protamex, liquipanol, papain, bromelain, ficin, an enzyme from Aspergillus oryzae, an enzyme from Bacillus subtilis var amyloliquifacians, a protease from Bacillus licheniformis, and pepsin from porcine and chicken stomachs.

41. The composition of claim 38, wherein said at least one proteolytic enzyme is present in said composition in an amount that is sufficient to hydrolyze said substantially piece-size-reduced animal source of protein.

42. The composition of claim 21, wherein said meat slurry composition is in a state that is one member chosen from a group comprising liquefied, pumpable, homogenous, flowable, and emulsified.

43. The composition of claim 42, wherein said pumpable includes capable of being pumped, through a pipe that has an internal diameter that is a value between about 2 inches and about 12 inches, at a flow rate that is value up to about 100,000 pounds of said activated meat mixture per hour.

44. A process for producing a meat slurry, said process comprising:
obtaining an animal source of protein;
reducing piece size of said animal source of protein to produce a smaller-piece-sized animal source of protein;
introducing one or more types of lactic acid producing bacteria and at least one carbohydrate energy source to said smaller-piece-sized animal source of protein to produce a meat mixture;
adding water to said meat mixture to produce an activated meat mixture;
incubating said activated meat mixture to produce a meat slurry; and
wherein said activated meat mixture has a pH value that is greater than about 5.0, and wherein prior to said incubating, said one or more types of lactic acid producing bacteria is present on said meat mixture in an amount that is at least about 1×10⁷ colony forming units (“CFU”) of said one or more types of lactic acid producing bacteria per gram of said meat mixture; and after said incubating, said one or more types of lactic acid producing bacteria produces lactic acid in an amount that is sufficient to maintain a pH of said meat slurry at a value that is no greater than about 4.7.

45. The process of claim 44, wherein said activated meat mixture has a pH value that is greater than about 5.5.

46. The process of claim 44, wherein said introducing is carried out prior to said reducing.

47. The process of claim 44, wherein said obtaining includes obtaining said animal source of protein from a slaughterhouse.

48. The process of claim 44, wherein said animal source of protein is intended primarily for pet food use.

49. The process of claim 44, further comprising, prior to said reducing, deboning said animal source of protein.

50. The process of claim 44, further comprising, prior to said reducing, maintaining said animal source of protein at a temperature value that is one value selected from a group comprising between about 32° and about 55° F., less than or equal to about 32° F., and between about 55° F. and about 95° F.

51. The process of claim 44, wherein said reducing piece size of said animal source of protein is carried out using a piece-sizing device that includes at least one member selected from a group comprising a chopper, a grinder, a cutter, a mechanical separator, a deboner, an emulsifier, a flaker, an extructor, a block breaker, a beehive, a pre-breaker, dicer, and removal of bones by hand.

52. The process of claim 44, wherein said reducing piece size of said animal source of protein includes at least one member selected from a group comprising emulsifying, grinding, and deboning.

53. The process of claim 44, wherein said reducing piece size of said animal source of protein produces a smaller-piece-sized animal source of protein such that a largest dimension of a substantial amount of said smaller-piece-sized animal source of protein does not exceed about 20 mm.

54. The process of claim 53, wherein said reducing piece size of said animal source of protein produces a smaller-piece-sized animal source of protein such that a largest dimension of a substantial amount of said smaller-piece-sized animal source of protein does not exceed about 10 mm.

55. The process of claim 44, wherein said introducing one or more types of lactic acid producing bacteria and said at least one carbohydrate energy source to said smaller-piece-sized animal source of protein is carried out in separate steps.

56. The process of claim 44, further comprising, prior to said introducing, mixing at least one of said one or more types of lactic acid producing bacteria and at least one of said carbohydrate energy source to produce a water-based mixture that used in said introducing.

57. The process of claim 56, wherein said mixing is carried out for a time value that is between about 15 minutes and about 30 minutes.

58. The process of claim 56, wherein a ratio of a weight of said water-based mixture to a sum weight of said one or more types of lactic acid producing bacteria and said at least one carbohydrate energy source is between about 15:1 and about 40:1.

59. The process of claim 58, wherein a ratio of a weight of said water-based solution to a sum weight of said one or more types of lactic acid producing bacteria and said at least one carbohydrate energy source is about 25:1.

60. The process of claim 44, further comprising, prior to said introducing, lyophilizing a mixture of said one or more types of lactic acid producing bacteria and said at least on carbohydrate energy source to produce a lyophilized starter culture that is used in said introducing.

61. The process of claim 44, further comprising, prior to said introducing, delivering said meat mixture to a holding tank.

62. The process of claim 61, wherein said holding tank includes at least one member selected from a group comprising a tote, a tank, and a tanker truck.

63. The process of claim 44, wherein said incubating is carried out in at least one member selected from a group comprising a heat exchanger, an oven, a steam injection, a hot plate, a microwave, a jacketed cookers, a jacketed blenders, a steam oven, a infrared oven, a baking oven, a elements, a convection oven, a conduction oven, a preconditioner, a dehydrator, a pressure cooker, an impingement oven, a smokehouse, a smoker, a vacuum cooker and a double boiler.

64. The process of claim 44, wherein said incubating includes pumping said meat mixture through a heat exchanger.

65. The process of claim 44, wherein said incubating is carried out at a temperature value that between about 90° F. and about 125° F.

66. The process of claim 44, wherein said incubating is carried out at a temperature value that is between about 105° F. and about 125° F.

67. The process of claim 44, wherein said incubating is carried out for a time value that is at least 4 hours.

68. The process of claim 44, wherein said incubating is carried out for a time value that is at least 6 hours.

69. The process of claim 44, wherein the moisture content of said activated meat mixture is at least about 70%.

70. The process of claim 44, further comprising pumping said meat slurry for further processing or storage.

71. The process of claim 70, wherein said pumping is carried out through a pipe that has an internal diameter that is a value between about 2 inches and about 12 inches, at a flow rate that is value up to about 100,000 pounds of said activated meat mixture per hour.

72. The process of claim 44, further comprising drying said meat slurry to produce a rendered meal.

73. The process of claim 44, further comprising adding said meat slurry to a pet food or to a human food.

74. The process of claim 44, wherein said pet food is at least one member selected from a group comprising extruded, expanded, retorted, baked, injection molded, chubbs, refrigerated, frozen, and a pet food treat.

75. The process of claim 44, further comprising storing said meat slurry at a temperature value that is between about 55° F. and about 85° F.

76. The process of claim 44, further comprising storing said meat slurry at a temperature value that is between about −20° F. and about 55° F.

77. The process of claim 44, further comprising storing said meat slurry for later consumption, processing, or addition to a food product.

78. The process of claim 77, wherein said storing is carried out for a time value that is at least 10 days.

79. The process of claim 77, wherein said storing is carried out for a time value that is between about 10 days and about 90 days.

80. The process of claim 77, wherein said storing is carried out for a time value that is greater than about 90 days.

81. The process of claim 77, further comprising storing said meat slurry at a temperature value that is between about 55° and about 85° F., for a time value that is between about 10 days and about 90 days, such that after said being stored, said meat slurry fit for consumption by a human or an animal.

82. The process of claim 77, further comprising storing said meat slurry at a temperature value that is between about 55° and about 85° F., for a time value that is between about 90 days and about 24 months, such that after said being stored, said composition is fit for consumption by a human or an animal.

83. The process of claim 77, further comprising storing said meat slurry at a temperature value that is between about 55° and about 85° F., for a time value that is greater than about 24 months, such that after said being stored, said meat slurry composition is fit for consumption by a human or an animal.

84. A process for producing an enzymatically digested meat slurry, said process comprising:
obtaining an animal source of protein;
reducing piece size of said animal source of protein to produce a smaller-piece-sized, animal source of protein;
adding at least one proteolytic enzyme to said smaller-piece-sized animal source of protein to produce a pre-digested, smaller-piece-sized animal source of protein;
digesting said pre-digested smaller-piece-sized animal source of protein to produce a digested smaller-piece-sized animal source of protein;
introducing one or more types of lactic acid producing bacteria and at least one carbohydrate energy source to said digested animal source of protein to produce a digested meat mixture; and
incubating said digested meat mixture to produce a digested meat slurry; and
wherein said digested meat mixture has a pH value that is greater than about 5.0, and after said introducing, said lactic acid producing bacteria is present on said digested meat mixture in an amount that is at least about 1×10⁷ CFU of bacteria per gram of said digested meat mixture, and said digested meat slurry has a pH value that is maintained at a level that is less than about 4.7.

85. The process of claim 84, wherein said at least one proteolytic enzyme includes at least one proteolytic enzyme selected from a group comprising a protease, a peptidase, an exo-peptidase, and an endo-peptidase.

86. The process of claim 84, wherein said at least one proteolytic enzymes includes at least one member selected from a group comprising sulfhydryl protease, serine protease, alcalase, flavourzyme, protamex, liquipanol, papain, bromelain, ficin, an enzyme from Aspergillus oryzae, an enzyme from Bacillus subtilis var amyloliquifacians, a protease from Bacillus licheniformis, and pepsin from porcine and chicken stomachs.

87. The process of claim 84, wherein said digesting includes heating said activated, smaller-piece-sized animal source of protein to a temperature value that is between about 130° F. and about 270° F.

88. The process of claim 84, wherein said digesting and said incubating are carried out in a single step.

89. The process of claim 84, wherein said digesting is carried out for a time value that is between about 20 minutes and about 240 minutes.

90. The process of claim 84, further comprising, prior to said introducing, adding water to said digested animal source of protein.

91. The process of claim 44, further comprising:
retaining a portion of said meat slurry;
adding, to said portion of said meat slurry, said or another of said smaller-piece-sized animal source of protein, to produce a smaller piece-sized animal source of protein/meat slurry combination;
mixing said smaller-piece-sized animal source of protein/meat slurry combination to produce a smaller-piece-sized animal source of protein/meat slurry mixture;
introducing, to said smaller-piece-sized animal source of protein/meat slurry mixture, said or another of said carbohydrate energy source and said water to produce an activated, smaller-piece-sized animal source of protein/meat slurry mixture; and
incubating said activated, smaller-piece-sized animal source of protein/meat slurry mixture to produce another meat slurry that is enriched with sufficient lactic acid, produced by said one or more types of lactic acid producing bacteria, such that a pH value of said another meat slurry is less than about 4.7.

92. The process of claim 91, further comprising, monitoring, prior to said retaining, said pH value of said meat slurry, such that said retaining is carried out after said pH of said meat slurry is a value that is less than about 4.7.

93. A process for producing a meat slurry, said process comprising:
obtaining an animal source of protein having a certain pH value;
reducing piece size of said animal source of protein to produce a smaller-piece-sized animal source of protein having said certain or greater than said certain pH value;
introducing one or more types of lactic acid producing bacteria and at least one carbohydrate energy source to said smaller-piece-sized animal source of protein to produce a meat mixture having said certain or greater than said certain pH value;
adding water to said meat mixture to produce an activated meat mixture having said certain or greater than said certain pH value; and
incubating said activated meat mixture to produce a meat slurry having a pH value that is less than said certain pH value.

94. The process of claim 93, wherein said one or more types of lactic acid producing bacteria is present on said meat mixture in an amount that is at least about 1×10⁷ colony forming units (“CFU”) of said one or more types of lactic acid producing bacteria per gram of said meat mixture.

95. The process of claim 93, wherein said certain pH value is greater than about 5.0, and wherein said meat slurry has a pH value that is less than about 4.7.
